(19) United States
(12) Patent Application Publication
(10) Pub. No.: US 2025/0254018 A1
(43) Pub. Date: Aug. 7, 2025

(54) CARRIER CONFIGURATION AND SCHEDULING FOR SUB-BAND FULL DUPLEX SYSTEMS

(71) Applicant: Telefonaktiebolaget LM Ericsson (publ), Stockholm (SE)

(72) Inventors: Stephen Grant, PLEASANTON, CA (US); Peter Alriksson, HÖRBY (SE); Jung-Fu Cheng, FREMONT, CA (US); Yuhang Liu, LUND (SE); Tai Do, LUND (SE); Narendar Madhavan, BARA (SE)

(21) Appl. No.: 18/856,619

(22) PCT Filed: Apr. 20, 2023
(86) PCT No.: PCT/EP2023/060307

§ 371 Date: Oct. 13, 2024

Related U.S. Application Data
(60) Provisional application No. 63/332,921, filed on Apr. 20, 2022.

(51) Int. Cl. H04L 5/14; H04L 27/26

(52) U.S. Cl. CPC H04L 5/14; H04L 27/2605

(57) ABSTRACT

Systems and methods for carrier configuration and scheduling for Subband Full Duplex (SBFD) operation in cellular communications system are disclosed. In one embodiment, a method performed by a User Equipment (UE) comprises receiving, from a network node, information that configures one or more subbands within a bandwidth of a carrier for subband full duplex operation. The received information comprises first information that configures a cell-specific Time Division Duplexing (TDD) symbol pattern for the carrier, wherein the TDD symbol pattern comprises a set of symbols. The received information further comprises second information that configures, for each symbol from at least a subset of the set of symbols within the TDD symbol pattern, one or more subbands for subband full duplex operation within the symbol. The method further comprises operating in accordance with the received information.

### TECHNICAL FIELD

The present disclosure relates to a cellular communications system and, more specifically, to subband full duplex operation in a cellular communications system.

### BACKGROUND

New Radio (NR) standard in the 3^{rd} Generation Partnership Project (3GPP) is being designed to provide service for multiple use cases such as enhanced Mobile Broadband (eMBB), Ultra-Reliable and Low-Latency Communication (URLLC), and Machine Type Communication (MTC). Each of these services has different technical requirements. For example, the general requirement for eMBB is high data rate with moderate latency and moderate coverage, while URLLC service requires a low latency and high reliability transmission but perhaps for moderate data rates.

One of the solutions for low latency data transmission is shorter transmission time intervals. In NR in addition to transmission in a slot, a mini-slot transmission is also allowed to reduce latency. A mini-slot may consist of any number of one (1) to fourteen (14) Orthogonal Frequency Division Multiplexing (OFDM) symbols. It should be noted that the concepts of slot and mini-slot are not specific to a specific service meaning that a mini-slot may be used for either eMBB, URLLC, or other services.

FIG. 1 illustrates an exemplary radio resource in NR.

In Rel-15 NR, a User Equipment (UE) can be configured with up to four carrier bandwidth parts in the downlink with a single downlink carrier bandwidth part being active at a given time. A UE can be configured with up to four carrier bandwidth parts in the uplink with a single uplink carrier bandwidth part being active at a given time.

An NR slot consists of several OFDM symbols, which according to current agreements is either seven (7) or fourteen (14) symbols for an OFDM subcarrier spacing less than or equal to 60 kilohertz (kHz) and fourteen (14) symbols for an OFDM subcarrier spacing greater than 60 kHz). FIG. 2 shows a slot with fourteen (14) OFDM symbols. In FIG. 2, Tₛ and T_{symb} denote the slot duration and OFDM symbol duration, respectively.

### FDD and TDD Systems

Transmission and reception from a node, e.g. a terminal in a cellular system, can be multiplexed in the frequency domain or in the time domain (or combinations thereof). Frequency Division Duplex (FDD) as illustrated to the left in FIG. 3 implies that downlink and uplink transmission take place in different, sufficiently separated, frequency bands. Time Division Duplex (TDD), as illustrated to the right in FIG. 3, implies that downlink and uplink transmission take place in different, non-overlapping time slots. Thus, TDD can operate in unpaired spectrum, whereas FDD requires paired spectrum.

Typically, the structure of the transmitted signal in a communication system is organized in the form of a frame structure. For example, NR uses ten equally sized slots per radio frame as illustrated in FIG. 4 for the case of 15 kHz subcarrier spacing.

In case of FDD operation (upper part of FIG. 4), there are two carrier frequencies, one for uplink transmission (f_{UL}) and one for downlink transmission (f_{DL}). At least with respect to the terminal in a cellular communication system, FDD can be either full duplex or half duplex. In the full duplex case, a terminal can transmit and receive simultaneously, while in half-duplex operation, the terminal cannot transmit and receive simultaneously (the base station is capable of simultaneous reception/transmission though, e.g. receiving from one terminal while simultaneously transmitting to another terminal). In Long Term Evolution (LTE), a half-duplex terminal is monitoring/receiving in the downlink except when explicitly being instructed to transmit in a certain subframe.

In case of TDD operation (lower part of FIG. 4), there is only a single carrier frequency, and uplink and downlink transmissions are always separated in time also on a cell basis. As the same carrier frequency is used for uplink and downlink transmission, both the base station and the mobile terminals need to switch from transmission to reception and vice versa. An essential aspect of any TDD system is to provide the possibility for a sufficiently large guard time where neither downlink nor uplink transmissions occur. This is required to avoid interference between uplink and downlink transmissions. For NR, this guard time is provided by special subframes, which are split into three parts: symbols for DL, a guard period (GP), and symbols for uplink. The remaining subframes are either allocated to uplink or downlink transmission.

In more detail, the following two Information Elements (IEs) are defined in current 3GPP specifications. The TDD pattern is typically configured with at least the first IE and optionally the 2^{nd} IE:
TDD-DL-UL-ConfigCommon (cell-specific), and
TDD-DL-UL-ConfigDedicated (UE-specific).

The first IE is cell specific (common to all UEs) and is provided by broadcast signaling. It provides the number of slots in the TDD pattern via a reference subcarrier spacing and a periodicity such that the S-slot pattern repeats every S slots. This IE allows for very flexible configuration of the pattern characterized as follows:
A number of full downlink slots at the beginning of the pattern configured by the parameter nDownlinkSlots.
A number of full uplink slots at the end of the pattern configured by the parameter nUplinkSlots
A number of downlink (‘D’) symbols following the full downlink slots configured by the parameter nDownlinkSymbols
A number of uplink (‘U’) symbols preceding the full downlink slots configured by the parameter nUplinkSlots.
If there is a gap between the last downlink symbol and the first uplink symbol, then all symbols in the gap are characterized as flexible (‘F’). A symbol classified as ‘F’ can be used for downlink or uplink. A UE determines the direction in one of the following two ways:
   Detecting a Downlink Control Information (DCI) that schedules/triggers a downlink (DL) signal/channel, e.g., Physical Downlink Shared Channel (PDSCH), Channel State Information Reference Signal (CSI-RS) or schedules/triggers an uplink (UL) signal/channel, e.g. Physical Uplink Shared Channel (PUSCH), Sounding Reference Signal (SRS), etc.
   By dedicated (UE-specific) signaling of the IE TDD-DL-UL-ConfigDedicated, this parameter overrides some or all of the ‘F’ symbols in the pattern, thus providing a semi-static indication of whether a symbol is classified as ‘D’ or ‘U’
Optionally, a 2^{nd} pattern that is concatenated to the first pattern can be configured as above. If a 2^{nd} pattern is configured, the constraint is that the sum of the periodicities of the two patterns must evenly divide 20 milliseconds (ms).

FIG. 5 shows an exemplary TDD DL/UL pattern configured by TDD-DL-UL-ConfigCommon. It consists of three (3) full ‘D’ slots, one (1) full ‘U’ slot, with a mixed slot in between consisting of four (4) ‘D’ symbols and three (3) ‘U’ symbols. The remaining seven (7) symbols in the mixed slot are classified as ‘F.’

If a UE is not configured with TDD-DL-UL-ConfigDedicated, then the pattern at the top of the diagram is what it assumes. As stated above, the network can make use of the ‘F’ symbols flexibly by scheduling/triggering either an uplink or a downlink signal/channel in a UE specific manner. This allows for very dynamic behavior: the direction is not known to the UE a priori; rather, the direction becomes known once the UE detects a DCI scheduling/triggering a particular DL or UL signal/channel.

In contrast, the DL/UL direction for some or all of the ‘F’ symbols in a particular slot can be provided to the UE in a semi-static manner by Radio Resource Control (RRC) configuring the UE with TDD-DL-UL-ConfigDedicated. The lower part of FIG. 5 shows three exemplary configurations for overriding ‘F’ symbols in Slot 3. If the IE indicates ‘allDownlink’ or ‘allUplink’ for a particular slot (or slots), then all ‘F’ symbols in the slot are converted to either ‘D’ or ‘U,’ respectively. If the IE indicates ‘explicit,’ then a number of symbols at the beginning of the slot and/or a number of symbols at the end of the slot are indicated as ‘D’ and ‘U,’ respectively. In the example shown at the bottom of FIG. 5, the first seven and the last five are indicated as ‘D’ and ‘U’, which converts some of the ‘F’ symbols (but not all in this example) to ‘D’ and ‘U.’

A key behavior in the above is that the UE-specific IE TDD-DI-UL-ConfigDedicated can only override (i.e., specify ‘D’ or ‘U’) for symbols that are configured as ‘F’ by the cell-specific IE TDD-DL-UL-ConfigCommon. In other words, a UE does not expect to have a ‘D’ symbol converted to ‘U’ or vice versa.

FIG. 6 shows three additional exemplary TDD DL/UL patterns configured by TDD-DL-UL-ConfigCommon. In the first and second patterns, there are no ‘F’ symbols; hence according to current behavior in the 3GPP Rel-17 specifications, the UE would not expect to be configured with TDD-DL-UL-ConfigDedicated. In the second pattern, all symbols in Slots 1, 2, and 3 are configured as ‘F’; hence, the UE could be configured with TDD-DL-UL-ConfigDedicated to provide a direction (‘D’ or ‘U’) for any or all symbols in these three slots. Note that the current (Rel-17) specifications allow the dedicated configuration of the TDD pattern on a slot-specific basis. In other words, TDD-DL-UL-ConfigDedicated is not restricted to be the same in each slot where ‘F’ symbols are overridden.

### Subband Full Duplex

As described in the last section, in a conventional TDD system, entire carrier bandwidth or all carriers in the same frequency band need to be utilizing the same DL transmission or UL reception directions. This is further illustrated in FIG. 7.

For the Rel-18 evolution of the NR system, 3GPP has decided to study the technical feasibilities and potential benefits of Subband Full Duplex (SBFD) systems.
In such a system, a portion of a wide bandwidth carrier may be used for a different direction than that of the rest of the carrier. This is illustrated in the left-hand side of FIG. 8. That is, unlike a conventional TDD system as shown on the left-hand side of FIG. 7 where the entire bandwidth is used for DL transmission in the first three slots, the center portion of the SBFD carrier is used for UL reception while the rest of the carrier continues to be used for DL transmission as shown in the left-hand side of FIG. 8.
Similarly, instead of utilizing all carriers for the same DL or UL directions in a conventional TDD system as shown in the right-hand side of FIG. 7, some carriers in the SBFD system can be used for a different direction than that of the other carriers as shown in the right-hand side of FIG. 8.

In the 3GPP Rel-18 study, the scope has been limited such that, in SBFD operation, only NR base stations (gNBs) transmit DL and receive UL simultaneously. An individual UE is scheduled in only one direction (DL or UL) at a time.

### Advanced Antenna Arrays for TDD Systems

Modern cellular wireless communication systems utilize advance antenna array systems to perform beamforming and Multiple Input Multiple Output (MIMO) transmission in order to enhance the coverage and throughput of the system. A generic exemplary antenna array for a TDD system is illustrated in FIG. 9. In such an exemplary array, multiple antenna elements are utilized and typically placed in a planar array with horizontal and vertical spacings suitable for the operating frequency bands. For a TDD base station, the antenna array is connected to a transmit (TX)/receive (RX) switch such that the same antenna array can be used for transmitting DL signals in a DL slot as well as used for receiving UL signals in an UL slot.

### Antenna Architecture I for SBFD Systems

In an SBFD system, the base station will need to perform DL transmission and UL reception simultaneously. It hence becomes necessary to utilize two antenna arrays for the two directions, respectively as illustrated in FIG. 10 where:
a first antenna array is utilized for UL reception only, and
a second antenna array is utilized for DL transmission only.

It is also generally necessary to introduce additional isolation material or mechanisms between the two antenna arrays to suppress the signal leaking from the TX array into the RX array. Without such isolation, the UL receiver can be de-sensitized due to the fact that the DL transmit power is generally much higher than the UL receive power.

### SUMMARY

Systems and methods are disclosed for carrier configuration and scheduling for Subband Full Duplex (SBFD) operation in cellular communications system. In one embodiment, a method performed by a User Equipment (UE) comprises receiving, from a network node, information that configures one or more subbands within a bandwidth of a carrier for subband full duplex operation. The received information comprises first information that configures a cell-specific Time Division Duplexing (TDD) symbol pattern for the carrier, wherein the TDD symbol pattern comprises a set of symbols. The received information further comprises second information that configures, for each symbol from at least a subset of the set of symbols within the TDD symbol pattern, one or more subbands for subband full duplex operation within the symbol. The method further comprises operating in accordance with the received information. In this manner, SBFD operation is provided for a cellular communications system and, as a result, performance of the system can be improved.

In one embodiment, the set of symbols comprises a set of flexible symbols. In one embodiment, receiving the information comprises receiving a cell-specific TDD downlink-uplink configuration that comprises the first information and receiving a UE-specific configuration that comprises the second information. In one embodiment, the same one or more subbands for subband full duplex operation are configured in each of the at least a subset of the set of flexible symbols. In another embodiment, different one or more subbands for subband full duplex operation are configured for at least two of the at least a subset of the set of flexible symbols. In one embodiment, the second information further configures a transmission direction for each of the one or more subbands for each of the at least a subset of the set of flexible symbols. In another embodiment, a transmission direction for each of the one or more subbands for each of the at least a subset of the set of flexible symbols is predefined. In one embodiment, the same one or more subbands are configured for all of the at least a subset of flexible symbols configured for subband full duplex operation and, for each subband of the one or more subbands, the transmission direction is the same within the subband for all of the at least a subset of the set of flexible symbols configured for subband full duplex operation. In another embodiment, the same one or more subbands are configured for all of the at least a subset of flexible symbols configured for subband full duplex operation and, for at least one subband of the one or more subbands, the transmission direction is different within the subband for at least two of the at least a subset of the set of flexible symbols configured for subband full duplex operation. In one embodiment, the at least a subset of the set of flexible symbols configured for subband full duplex operation is predefined. In another embodiment, the received information further comprises information that indicates the at least a subset of the set of flexible symbols configured for subband full duplex operation.

In one embodiment, the set of symbols comprises a set of downlink symbols. In one embodiment, for each downlink symbol from the at least a subset of the set of downlink symbols within the TDD symbol pattern, the one or more subbands for subband full duplex operation within the downlink symbol consist of a single subband, wherein a transmission direction for the signal subband is the uplink direction. In one embodiment, resource blocks that are not part of the single subband are implicitly indicated as being one or more subbands for downlink transmission for subband full duplex operation. In another embodiment, the received information further comprises information that indicates a guardband on either or both sides of the single subband. In one embodiment, resource blocks that are not part of the single subband and not part of the guardband on either or both sides of the single subband are implicitly indicated as being one or more subbands for downlink transmission for subband full duplex operation. In one embodiment, the at least a subset of the set of downlink symbols that are configured for subband full duplex operation is predefined. In another embodiment, the received information further comprises information that indicates the at least a subset of the set of downlink symbols that are configured for subband full duplex operation.

In one embodiment, the set of symbols comprises a set of uplink symbols. In one embodiment, for each uplink symbol from the at least a subset of the set of uplink symbols within the TDD symbol pattern, the one or more subbands for subband full duplex operation within the uplink symbol consist of a single subband, wherein a transmission direction for the signal subband is the downlink direction. In one embodiment, resource blocks that are not part of the single subband are implicitly indicated as being one or more subbands for uplink transmission for subband full duplex operation. In another embodiment, the received information further comprises information that indicates a guardband on either or both sides of the single subband. In one embodiment, resource blocks that are not part of the single subband and not part of the guardband on either or both sides of the single subband are implicitly indicated as being one or more subbands for uplink transmission for subband full duplex operation. In one embodiment, the at least a subset of the set of uplink symbols that are configured for subband full duplex operation is predefined. In another embodiment, the received information further comprises information that indicates the at least a subset of the set of uplink symbols that are configured for subband full duplex operation.

In one embodiment, the second information that configures the one or more subbands for subband full duplex operation comprises information that indicates a start resource block index for at least one of the one or more subbands and information that indicates a number of contiguous resource blocks for the at least one of the one or more subbands. In another embodiment, the second information that configures the one or more subbands for subband full duplex operation comprises information that indicates a start resource block index for at least one of the one or more subbands and information that indicates a stop resource block index for the at least one of the one or more subbands. In another embodiment, the second information that configures the one or more subbands for subband full duplex operation comprises a bitmap that indicates resource blocks allocated for at least one of the one or more subbands.

In one embodiment, the received information further comprises information that indicates one or more guard bands between the one or more subbands. In one embodiment, the information that indicates the one or more guard bands between the one or more subbands comprises, for each guard band of the one or more guard bands, information that explicitly configures the guard band. In another embodiment, the information that indicates the one or more guard bands between the one or more subbands comprises, for each guard band of the one or more guard bands, a starting resource block index for the guard band and a number of contiguous resource blocks for the guard band.

In one embodiment, the method further comprises performing one or more actions to handle one or more downlink signals or one or more downlink channels that overlap at least one of the one or more subbands configured for uplink transmission for subband full duplex operation within at least one symbol and/or overlap at least one guard band configured on either side of at least one of the one or more subbands configured for uplink transmission for subband full duplex operation within at least one symbol. In one embodiment, the one or more actions comprise: refraining from attempting to receive a downlink signal or channel in one or more resource blocks in which the downlink signal or channel overlaps at least one of the one or more subbands configured for uplink transmission for subband full duplex operation within at least one symbol or overlaps at least one guard band configured on either side of at least one of the one or more subbands configured for uplink transmission for subband full duplex operation within at least one symbol; rate-matching around one or more resource blocks in which the downlink signal or channel overlaps at least one of the one or more subbands configured for uplink transmission for subband full duplex operation within at least one symbol or overlaps at least one guard band configured on either side of at least one of the one or more subbands configured for uplink transmission for subband full duplex operation within at least one symbol; or puncturing a downlink signal or channel in one or more resource blocks in which the downlink signal or channel overlaps at least one of the one or more subbands configured for uplink transmission for subband full duplex operation within at least one symbol or overlaps at least one guard band configured on either side of at least one of the one or more subbands configured for uplink transmission for subband full duplex operation within at least one symbol.

In one embodiment, the method further comprises performing one or more actions to handle one or more uplink signals or one or more uplink channels that overlap at least one of the one or more subbands configured for downlink transmission for subband full duplex operation within at least one symbol and/or overlap at least one guard band configured on either side of at least one of the one or more subbands configured for downlink transmission for subband full duplex operation within at least one symbol. In one embodiment, the one or more actions to handle one or more uplink signals or one or more uplink channels that overlap at least one of the one or more subbands configured for downlink transmission for subband full duplex operation within at least one symbol and/or overlap at least one guard band configured on either side of at least one of the one or more subbands configured for downlink transmission for subband full duplex operation within at least one symbol comprise: refraining from transmitting an uplink signal or channel in one or more resource blocks in which the uplink signal or channel overlaps at least one of the one or more subbands configured for downlink transmission for subband full duplex operation within at least one symbol or overlaps at least one guard band configured on either side of at least one of the one or more subbands configured for downlink transmission for subband full duplex operation within at least one symbol; or rate-matching around one or more resource blocks in which the uplink signal or channel overlaps at least one of the one or more subbands configured for downlink transmission for subband full duplex operation within at least one symbol or overlaps at least one guard band configured on either side of at least one of the one or more subbands configured for downlink transmission for subband full duplex operation within at least one symbol.

In one embodiment, each of the one or more subbands is a set of one or more contiguous resource blocks.

In one embodiment, the one or more subbands comprise two or more subbands.

In one embodiment, subband full duplex operation is operation in which the network node simultaneously transmits and receives.

Corresponding embodiment of a UE are also disclosed. In one embodiment, a UE comprises a communication interface comprising a transmitter and a receiver, and processing circuitry associated with the communication interface. The processing circuitry configured to cause the UE to receive, from a network node, information that configures one or more subbands within a bandwidth of a carrier for subband full duplex operation. The received information comprises first information that configures a cell-specific TDD symbol pattern for the carrier, wherein the TDD symbol pattern comprises a set of symbols. The received information further comprises second information that configures, for each symbol from at least a subset of the set of within the TDD symbol pattern, one or more subbands for subband full duplex operation within the symbol. The processing circuitry is further configured to cause the UE to operate in accordance with the received information.

Embodiments of method performed by a network node are also disclosed. In one embodiment, a method performed by a network node comprises transmitting, to a UE, information that configures one or more subbands within a bandwidth of a carrier for subband full duplex operation. The transmitted information comprises first information that configures a cell-specific TDD symbol pattern for the carrier, wherein the TDD symbol pattern comprises a set of symbols. The transmitted information further comprises second information that configures, for each symbol from at least a subset of the set of symbols within the TDD symbol pattern, one or more subbands for subband full duplex operation within the symbol.

Corresponding embodiments of a network node are also disclosed. In one embodiment, a network node comprises a communication interface and processing circuitry associated with the communication interface. The processing circuitry is configured to cause the network node to transmit, to a UE, information that configures one or more subbands within a bandwidth of a carrier for subband full duplex operation. The transmitted information comprises first information that configures a cell-specific TDD symbol pattern for the carrier, wherein the TDD symbol pattern comprises a set of symbols. The transmitted information further comprises second information that configures, for each symbol from at least a subset of the set of symbols within the TDD symbol pattern, one or more subbands for subband full duplex operation within the symbol.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an exemplary radio resource in New Radio (NR);

FIG. 2 shows a slot with fourteen Orthogonal Frequency Division Multiplexing (OFDM) symbols;

FIG. 3 illustrates Frequency Division Duplex (FDD) and Time Division Duplex (TDD) on the left-hand and right-hand sides of the figure, respectively;

FIG. 4 illustrates examples of the uplink/downlink time/frequency structure in case of FDD or TDD;

FIG. 5 shows an exemplary TDD downlink (DL)/uplink (UL) pattern configured by TDD-DL-UL-ConfigCommon;

FIG. 6 shows three additional exemplary TDD DL/UL patterns configured by TDD-DL-UL-ConfigCommon;

FIG. 7 illustrates a conventional TDD carrier or carrier system;

FIG. 8 illustrates examples of a subband full duplex (SBFD) carrier and system;

FIG. 9 illustrates a generic exemplary antenna array for a TDD system;

FIG. 10 illustrates an example of an antenna architecture for SBFD systems;

FIG. 11 illustrates an example Resource Block (RB) set configuration for a first embodiment of the present disclosure;

FIG. 12 illustrates an example configuration of three RB sets in an SBFD symbol, in accordance with an embodiment of the present disclosure;

FIG. 13 illustrates an example RB set configuration for a second embodiment of the present disclosure;

FIG. 14 illustrates an example configuration of a single ‘U’ RB set in an SBFD symbol, in accordance with an embodiment of the present disclosure;

FIG. 15 illustrates an example RB set configuration for a third embodiment of the present disclosure;

FIG. 16 illustrates an example configuration of a single ‘D’ RB set in an SBFD symbol, in accordance with an embodiment of the present disclosure;

FIG. 17 illustrates example frequency domain resource allocations for DL signals/channels that partially or fully overlap an ‘U’ RB set and/or RBs of the guard band(s), in accordance with one embodiment of the present disclosure;

FIG. 18 illustrates example frequency domain resource allocations for UL signals/channels that partially or fully overlap a ‘D’ RB set and/or RBs of the guard band(s), in accordance with one embodiment of the present disclosure;

FIG. 19 illustrates the operation of a network node and a User Equipment (UE) in accordance with at least some embodiments of the present disclosure;

FIG. 20 shows an example of a communication system in accordance with some embodiments;

FIG. 21 shows a UE in accordance with some embodiments;

FIG. 22 shows a network node in accordance with some embodiments;

FIG. 23 is a block diagram of a host, which may be an embodiment of the host of FIG. 20, in accordance with various aspects described herein;

FIG. 24 is a block diagram illustrating a virtualization environment in which functions implemented by some embodiments may be virtualized; and

FIG. 25 shows a communication diagram of a host communicating via a network node with a UE over a partially wireless connection in accordance with some embodiments.

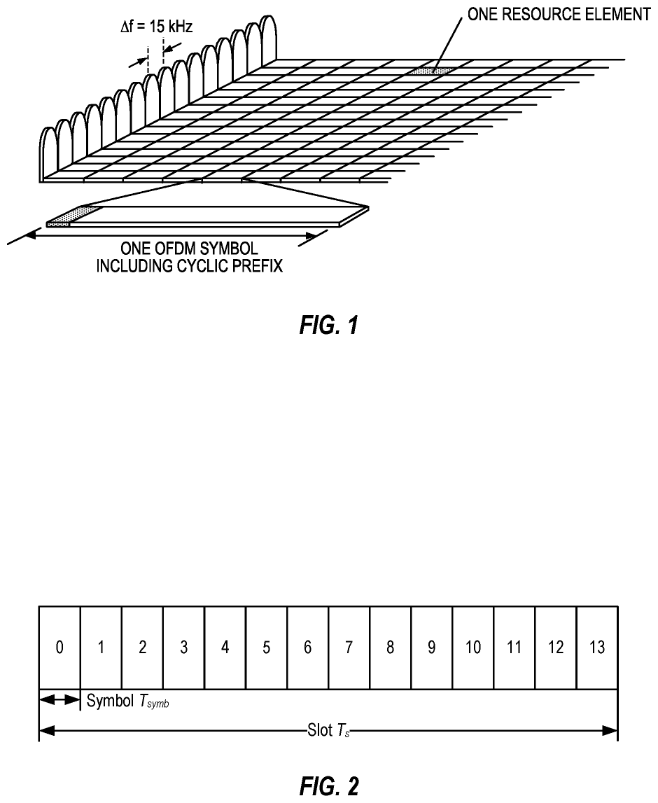

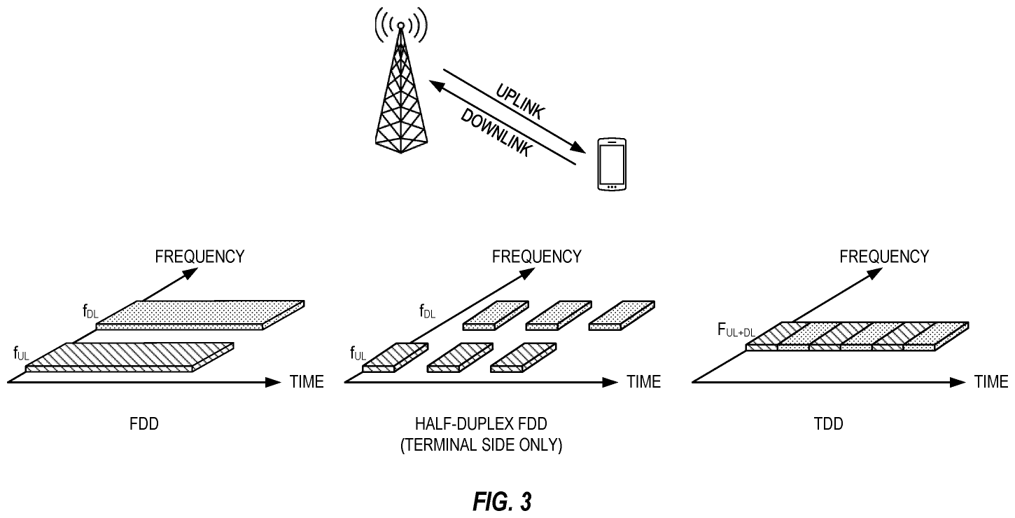

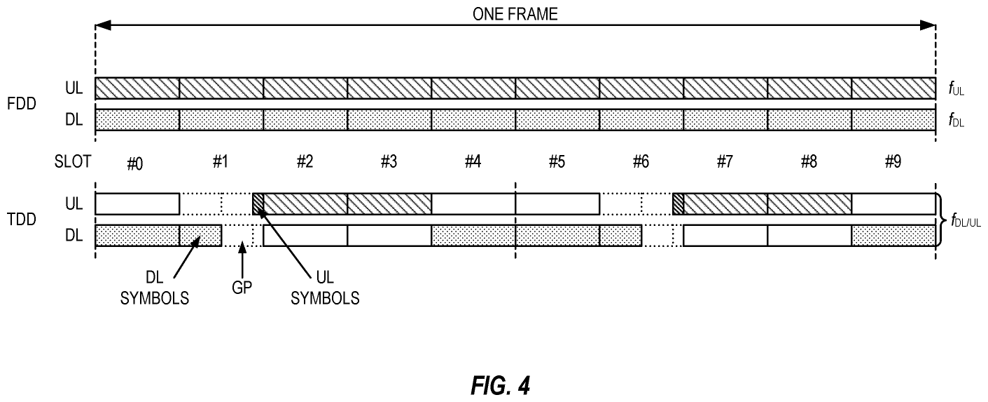

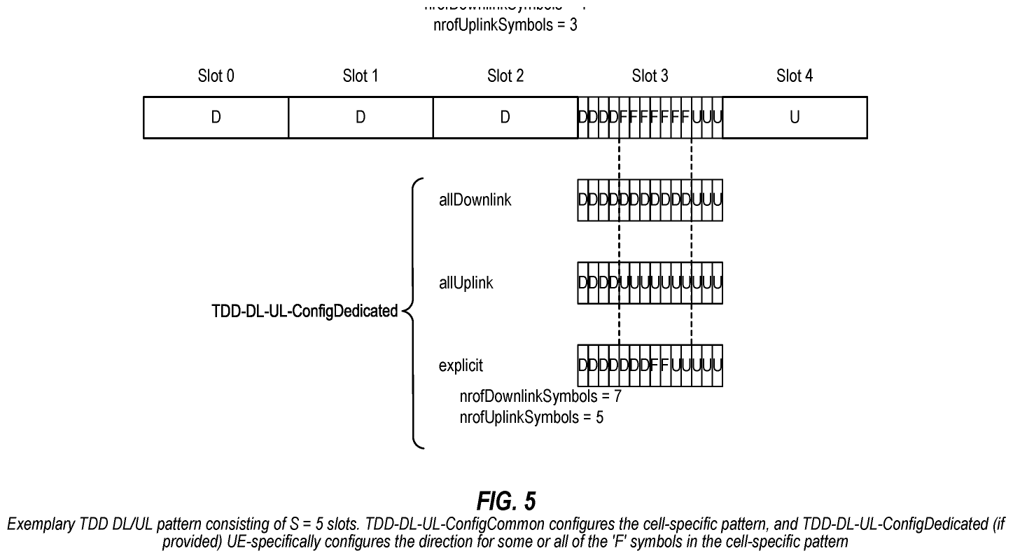

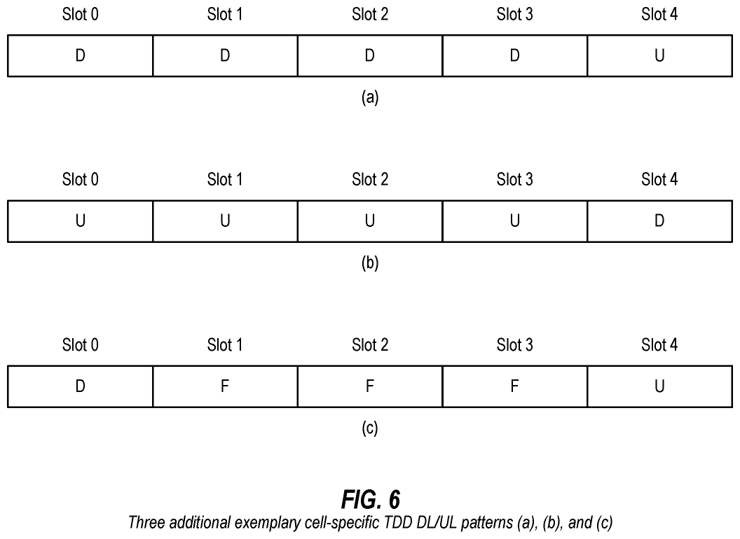

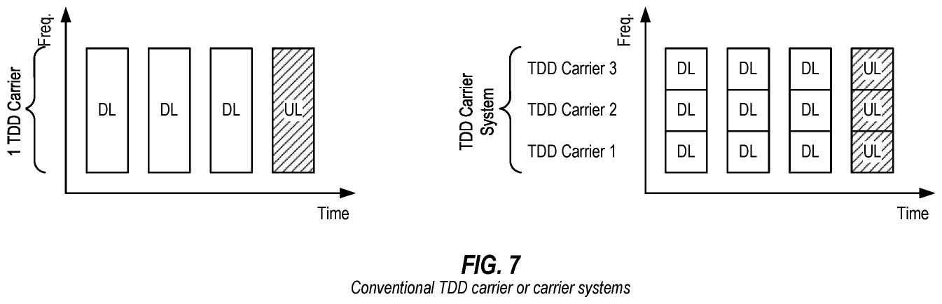

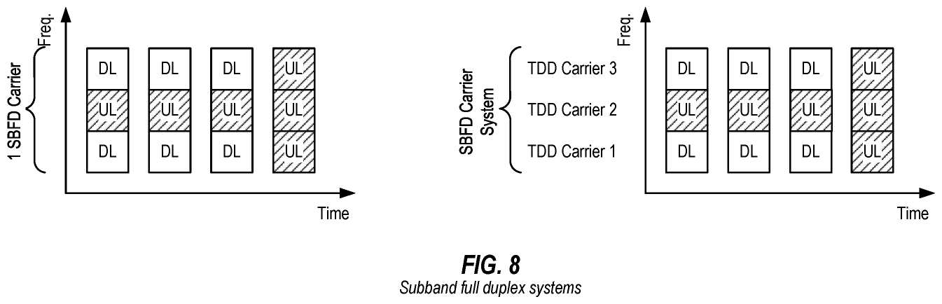

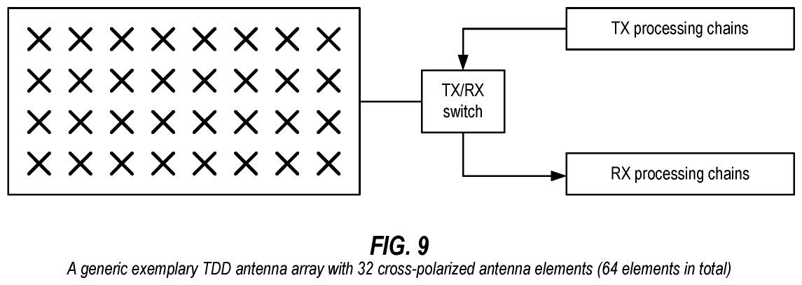

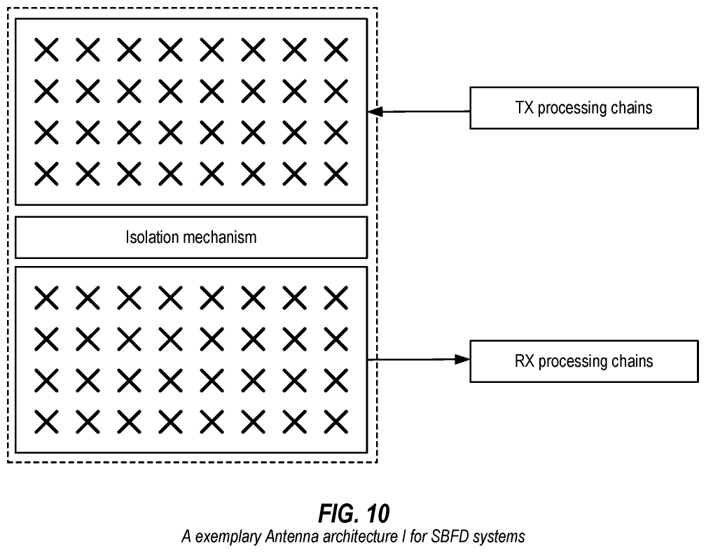

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). The current (Rel-17) 3^{rd} Generation Partnership Project (3GPP) specifications are restricted such that cell-specific and User Equipment (UE)-specific configuration of the downlink (DL)/uplink (UL) pattern via TDD-DL-UL-ConfigCommon and TDD)-DL-UL-ConfigDedicated, respectively, indicate the same direction (‘D’ or ‘U’) for the whole bandwidth of a configured carrier. It is an open problem how to configure the UE with subbands with different directions, e.g., D-U-D, within the same carrier. Furthermore, it is an open problem on how the UE should behave if it is scheduled/triggered with specific signals/channels that may conflict with the direction of a particular sub-band, e.g., a DL signal that partially or fully overlaps a ‘U’ subband.

Certain aspects of the disclosure and their embodiments may provide solutions to these or other challenges. A first set of embodiments provide solutions for semi-statically configuring a carrier with Resource Block (RB) sets where each RB set corresponds to a particular subband of the carrier and is assigned a direction as ‘D,’ ‘U,’ or ‘F.’

A second set of embodiments provides solutions for UE procedures to handle the case when a scheduled/triggered signal/channel partially or fully overlaps an RB set with an incompatible direction, e.g., DL signal overlaps ‘U’ RB set.

Embodiments of a method of configuring and operating a carrier with RB sets corresponding to DL and UL subbands of the carrier to enable Subband Full Duplex (SBFD) operation are disclosed.

Certain embodiments may provide one or more of the following technical advantage(s). Embodiments of the present disclosure may provide enhanced beamforming performance for the SBFD systems.

In the following embodiments, an SBFD symbol is a symbol that is configured such that it can be used for SBFD operation, i.e., simultaneous transmission/reception within the same carrier. Note that while an SBFD symbol may be used for simultaneous transmission/reception, it is not restricted to simultaneous transmission/reception. At any given time instant, the symbol may be used for only transmission or only reception.

In the following embodiments, the following existing (Rel-17) Information Elements (IEs) for configuring Time Division Duplexing (TDD) DL/UL patterns (see the Background for further information) are referred to:
TDD-DL-UL-ConfigCommon (cell-specific), and
TDD-DL-UL-ConfigDedicated (UE-specific).

### Embodiment #1: SBFD Symbols Configured as Flexible (‘F’) by TDD-DL-UL-ConfigCommon

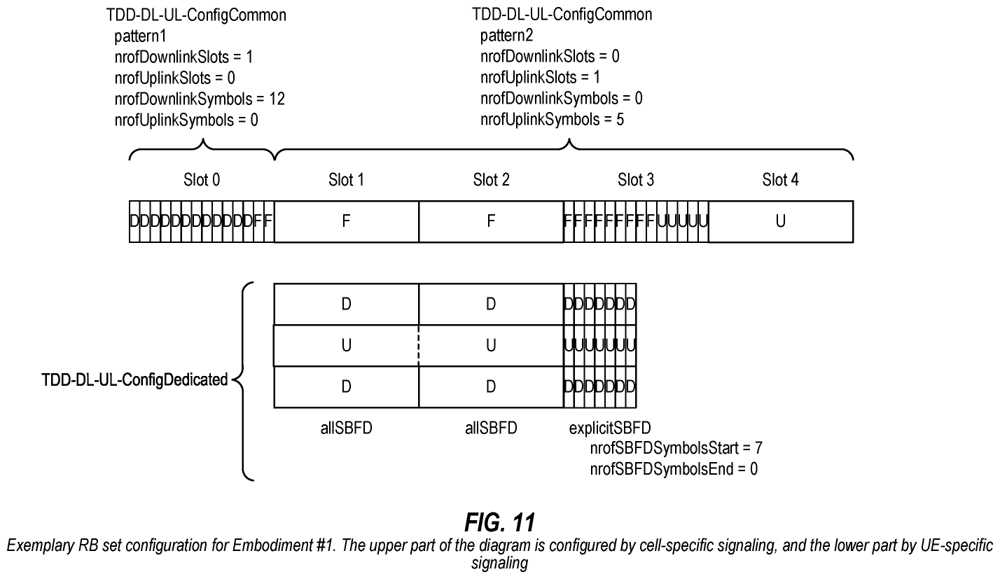

In this embodiment, the cell-specific IE TDD-DL-ULConfigCommon configures a set of symbols in the TDD pattern as flexible (‘F’), some or all of which will be used for SBFD operation—see an example in the upper part of FIG. 11. These symbols are configured as ‘F’ in order to adhere to procedures defined in the current (Rel-17) specifications in which a DL or UL direction provided by the UE specific IE TDD-DL-ULConfigDedicated can only override symbols configured as flexible (‘F’) by the cell-specific IE TDD-DL-ULConfigCommon. Current specifications do not allow UE-specific signaling to change the direction indicated by cell-specific signaling, i.e., D cannot override U and vice versa.

The cell-specifically configured TDD pattern in the example in the upper part of the FIG. 11 consists of five slots and is defined from two concatenated sub-patterns (pattern 1 and pattern2). The overall pattern has a number of DL-only symbols at the beginning of the pattern and a number of UL-only symbols at the end of the pattern. In between are the ‘F’ symbols, some or all of which will be used for SBFD operation. Configuration of such a cell-specific pattern is supported already in current (Rel-17) specifications. Hence, this pattern is valid for both new UEs that support SBFD operation and legacy UEs that are not capable of SBFD operation.

This embodiment discloses an approach to enable SBFD operation in which a new parameter is defined in order to configure a new SBFD capable UE with DL and UL subband(s) within each Orthogonal Frequency Division Multiplexing (OFDM) symbol that will be used for SBFD operation (see an example in the lower part of FIG. 11). While this parameter is described herein as being contained within the UE-specific IE TDD-DL-UL-ConfigDedicated, this should be viewed as a non-limiting example. Alternatively, the new parameter could be defined outside of TDD-DL-UL-ConfigDedicated. The new parameter could even be contained within a cell-specifically configured information element, but available as an extension only available to new (SBFD capable) UEs.

It is to be understood that the new parameter is used to enable SBFD operation for new SBFD capable UEs. For legacy UEs not capable of SBFD operation, if it is desired to semi-statically configure the transmission direction (‘D’ or ‘U’) rather than leaving the symbols configured by TDD-DL-ULConfigCommon as ‘F’, then the legacy (Rel-17) version of TDD-DL-ConfigDedicated is used for this purpose. For such UEs, there is only one transmission direction in an OFDM symbol, common for the full carrier bandwidth.

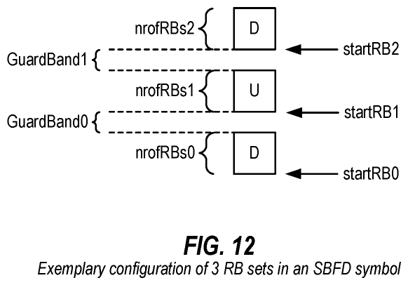

The new parameter for SBFD capable UEs enables indication of at least two sets of contiguous RBs, called RB sets for each symbol configured for SBFD operation. In one non-limiting example (see FIG. 12), three RB sets are configured, where the configuration for each RB set consists of the following:
Start RB index, and
Number of contiguous RBs.

If the start RB index and number of contiguous RBs are set in such a way that there is a gap between the RB sets, this gap is considered as a guard band which is used neither for DL nor UL. Two such guardbands are shown in the example in FIG. 12. In variations of this embodiment, the RB sets can be configured via other means, e.g., start/stop RB index for each RB set, or a bitmap indicating which RBs are allocated for an RB set, etc. In other variations, the guard bands can be configured explicitly, e.g., with a starting index and number of contiguous RBs for each guardband. This can be within the same parameter or in a separate parameter.

In the preferred embodiment, the transmission direction of each RB set is fixed by specification. In one non-limiting example, if three RB sets are configured, specifications will dictate that the RB sets have direction D-U-D, as shown in the example in FIG. 12. In a variation of the embodiment, the new parameter additionally enables explicit indication of the transmission direction for each of the configured RB sets:
In one variation, each RB set is configured as either ‘D’, ‘U’, or ‘F’ leading to N³ possible combinations where N is the number of RB sets.
In another variation, a restricted set of combinations is defined, and an index indicates which combination from the restricted set is configured.
   For the example of three RB sets, and exemplary restricted set consists of two combinations {D-U-D, U-D-U} and an index selects which combination is configured

In the preferred embodiment, the transmission direction of the RB sets is the same for all SBFD symbols in the TDD pattern. In a variation of the embodiment, the new parameter additionally enables configuration of the transmission direction of the RB sets to be different for different SBFD symbols.

In one variation of the embodiment, the UE implicitly assumes that all symbols configured as ‘F’ in the cell-specifically configured TDD pattern are configured for SBFD operation. In another variation, the new parameter explicitly indicates a subset of ‘F’ symbols that are configured for SBFD operation. The indication can be on a granularity of slots or symbols, or both. In the example shown in the lower part of FIG. 11, all symbols of slots 1 and 2 and the first 7 symbols of slot 3 are indicated. In this example, the first two and the last two ‘F’ symbols are not used for SBFD operation. These symbols could serve as a guard period during which the transmitter hardware can be reconfigured, if needed, to support SBFD operation. The remaining symbols in the TDD pattern are used for DL-only or UL-only transmission as configured by the cell-specific IE TDD-DL-ULConfigCommon.

In another non-limiting example, the SBFD indication parameter indicates a starting slot offset, a starting symbol offset, and a number of symbols (or an ending slot offset and ending symbol offset) for a set of consecutive SBFD symbols, wherein the slot and symbol offsets are with respect to the first symbol or the first ‘F’ symbol in the corresponding TDD pattern. Furthermore, the SBFD indication parameters can indicate multiple sets of aforementioned parameters to specify multiple sets of consecutive SBFD symbols in a TDD pattern.

In yet another non-limiting example, the SBFD indication parameter is a bitmask, wherein each bit represents a slot or a symbol in the corresponding TDD pattern (or only the ‘F’ slots or symbols in the TDD pattern) in a time-ascending order, with 1 indicating a SBFD slot or symbol and 0 indicating a ‘F’ slot or symbol.

In one embodiment, the subbands, or RB sets, for which SBFD operation is configured are the same for all SBFD symbols in the TDD pattern. So, for example, if there are 100 RBs in each SBFD symbol and there is a D-U-D split in each SBFD symbol, the same RB sets (or subbands) are used for the D-U-D split in all of the SBFD symbols. In another embodiment, the subbands, or RB sets, for which SBFD operation is configured may be different for different SBFD symbols in the TDD pattern. So, for example, if there are 100 RBs in each SBFD symbol and there is a D-U-D split in each SBFD symbol, different RB sets (or subbands) may be used for the D-U-D split in two or more of the SBFD symbols (e.g., 40 RB-20 RB-40 RB split in one SBFD symbol and a 30 RB-40 RB-30 RB split in another SBFD symbol).

Another aspect of this embodiment addresses the fact that the existing (Rel-17) UE procedures defined for TDD always assume that only downlink is received in ‘D’ (or ‘F’) symbols and only uplink is transmitted in ‘U’ (or ‘F’) symbols. These procedures require modification to support SBFD. With the RB sets as defined and configured in this embodiment, an exemplary modification of a procedure is as follows:
In the preface to the procedure, change the wording “for a set of symbols of a slot that are indicated to the UE as (flexible/downlink/uplink) . . . [Procedure text]”
   to
“for a set of symbols of a slot that are indicated to the UE as (flexible/downlink/uplink), or for RB sets for a set of symbols of a slot indicated to the UE as (flexible/downlink/uplink), . . . [Procedure text]”

In this way Rel-17 procedures are extended naturally to include SBFD operation in which DL and UL transmissions occur simultaneously within the same carrier for new SBFD capable UEs.

### Embodiment #2: SBFD Symbols Configured as Downlink (‘D’) by TDD-DL-UL-ConfigCommon

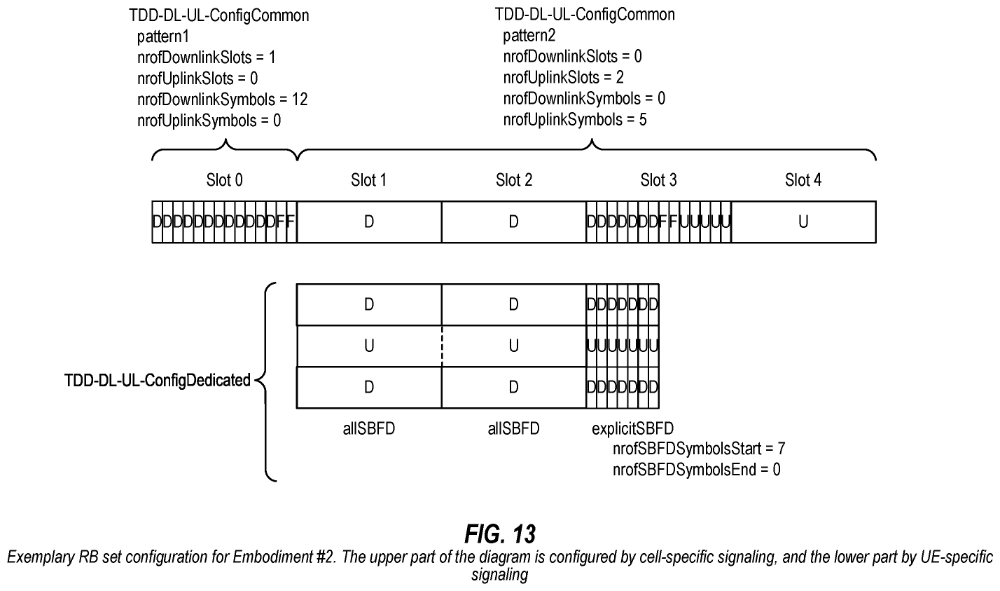

This embodiment is similar to Embodiment #1, except that the cell-specific IE TDD-DL-ULConfigCommon configures the symbols that will be used for SBFD operation as downlink (‘D’) rather than flexible (‘F’) as in Embodiment #1—see an example in the upper part of FIG. 13. An advantageous aspect of this embodiment is that for legacy (non-SBFD capable UEs), it is not necessary to signal the legacy (Rel-17) UE-specific IE TDD-DL-UL-ConfigDedicated in order to configure the transmission direction as ‘D’ for these UEs. The cell-specific signaling already provides the direction.

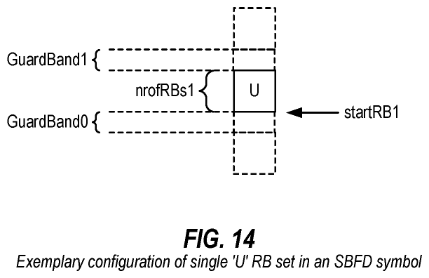

In this embodiment, a new parameter for SBFD capable UEs enables indication of a single RB set with direction implicitly indicated as ‘U.’ In one non-limiting example, the configuration of the single RB set consists of at least following (see FIG. 14):
Start RB index, and
Number of contiguous RBs.

In a variation of this embodiment, the new parameter can additionally indicate a number of RBs on either side of the RB set as guardbands.

In this embodiment, the RBs not configured as the ‘U’ RB set or as guard bands, are implicitly determined by the UE to comprise ‘D’ RB sets, consistent with the ‘D’ direction indicated by cell-specific IE TDD-DL-ULConfigCommon.

In one variation of this embodiment, the UE implicitly assumes that all symbols configured as ‘D’ in the cell-specifically configured TDD pattern are configured for SBFD operation. In another variation, the new parameter explicitly indicates a subset of ‘D’ symbols that are configured for SBFD operation. The indication can be on a granularity of slots or symbols, or both. In the example shown in the lower part of FIG. 13, all symbols of slots 1 and 2 and the first seven symbols of slot 3 are indicated. In this example, the first two and the last two ‘F’ symbols are not used for SBFD operation. These symbols could serve as a guard period during which the transmitter hardware can be reconfigured, if needed, to support SBFD operation. The remaining symbols in the TDD pattern are used for DL-only or UL-only transmission as configured by the cell-specific IE TDD-DL-ULConfigCommon.

### Embodiment #3: SBFD Symbols Configured as Uplink (‘U’) by TDD-DL-UL-ConfigCommon

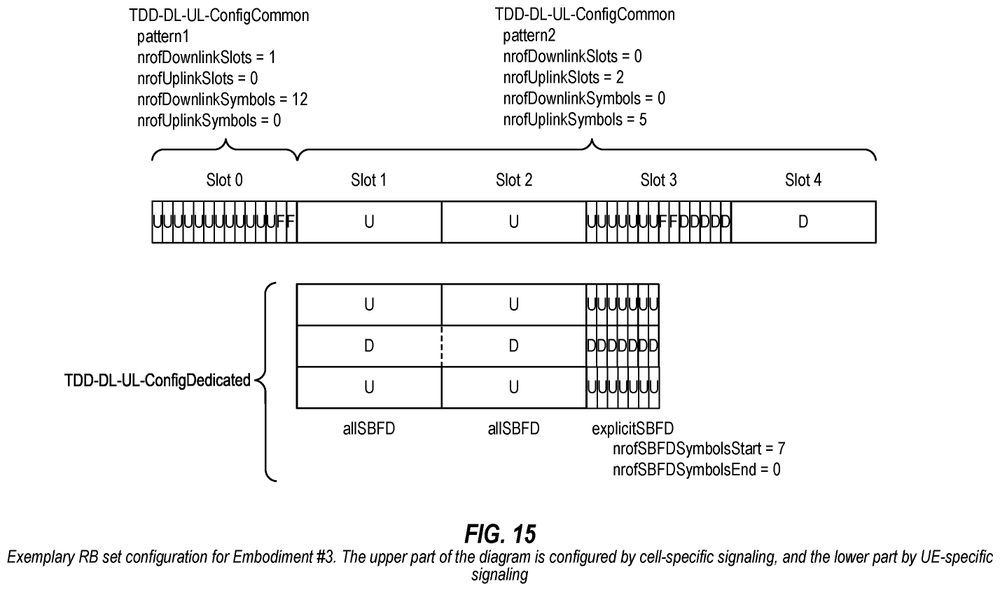

This embodiment is the converse of Embodiment #2, wherein the cell-specific IE TDI)-DL-ULConfigCommon configures the symbols that will be used for SBFD operation as uplink (‘U’) rather than downlink (‘D’) as in Embodiment #2—see an example in the upper part of FIG. 15.

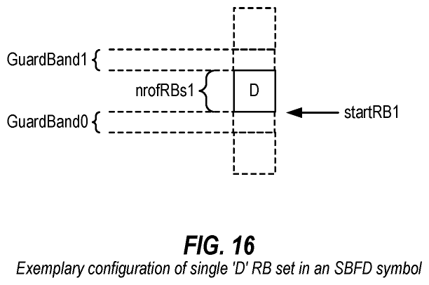

In this embodiment, a new parameter for SBFD capable UEs enables indication of a single RB set with direction implicitly indicated as ‘D’ (see example in FIG. 16). The RBs not configured as the ‘D’ RB set or as guard bands, are implicitly determined by the UE to comprise ‘U’ RB sets, consistent with the ‘U’ direction indicated by cell-specific IE TDD-DL-ULConfigCommon.

### Embodiment #4: Handling of DL Signals/Channels that Overlap ‘U’ RB Set

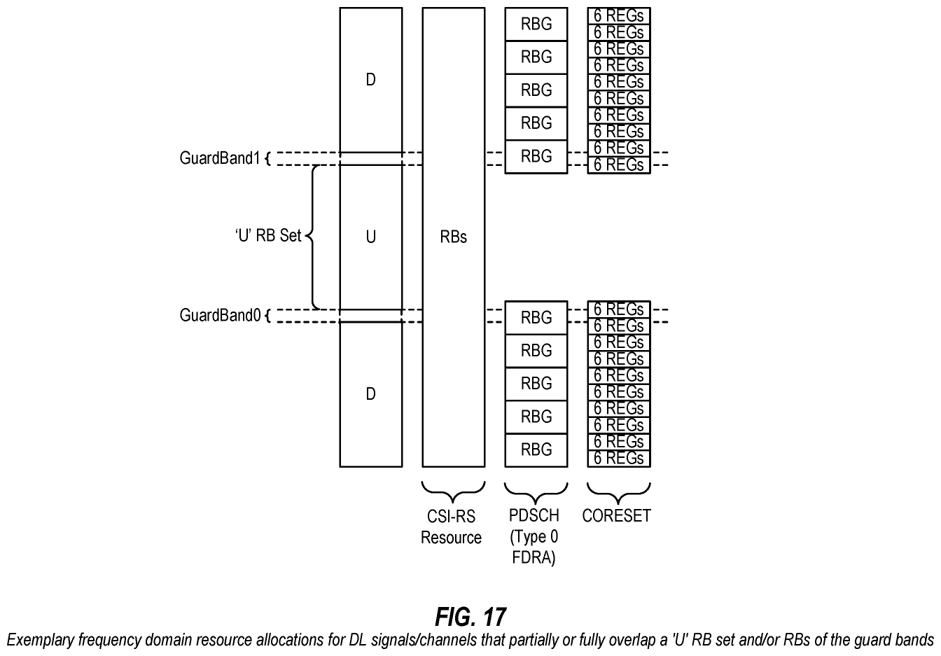

This embodiment relates to UE procedures for handling DL signals or channels that either fully or partially overlap RBs of a ‘U’ RB set and/or overlap RBs of one or both guard bands on either side of a ‘U’ RB set. This situation can occur, for example, if a Channel State Information Reference Signal (CSI-RS) resource is configured a number of RBs that span the full carrier bandwidth. Another example is if the Type0 Frequency Domain Resource Allocation (FDRA) for Physical Downlink Shared Channel (PDSCH) indicates one or more resource block groups (RBGs) that partially overlaps a ‘U’ RB set and/or RBs of a guard band. Yet another example is if a Control Resource Set (CORESET) configuration for Physical Downlink Control Channel (PDCCH) indicates that one or more groups of 6 RBs (each referred to as a resource element group (REG)) overlaps a ‘U’ RB set and/or RBs of a guard band. These three scenarios are illustrated in FIG. 17.

The following sub-embodiments of Embodiment #4 are disclosed:

### Embodiment #4-1: CSI-RS

If a UE receives a CSI-RS resource configuration in which one or more RBs overlap a ‘U’ RB set and/or a guard band on one or both sides of the ‘U’ RB set, the UE drops those RBs of the configuration. In this context, ‘drop’ means that it does not attempt to receive CSI-RS in those RBs.

### Embodiment #4-2: PDSCH/SPS

If a UE receives a FDRA for PDSCH or SPS in which one or more RBs overlap a ‘U’ RB set and/or a guard band on one or both sides of the ‘U’ RB set, the UE rate matches around those RBs. In this context ‘rate matching’ means that the UE assumes that resources are not allocated to PDSCH in those RBs.

For the case of Type0 FDRA for PDSCH, the UE rate matches around all RBs of one or more resource block groups (RBGs) that partially overlap the ‘U’ RB set and/or a guard bands. In a variation, the UE rate matches around a subset of the RBs of each of the RBG(s), where the subset consists of the RBs that overlap the ‘U’ RB set and/or guard band. In this sense, the size of one or more of the allocated RBGs in the Type0 FDRA is automatically adjusted to account for overlap.

### Embodiment #4-3: PDCCH

If the PDCCH candidate associated with a CORESET configured to a UE contains one or more REGs (equivalent to an RB) of a group of 6 REGs that overlap a ‘U’ RB set and/or a guard band on one or both sides of the ‘U’ RB set, the UE punctures all REGs of each group of 6 REG(s) that overlap the ‘U’ RB set and/or guard band. In a variation, the UE punctures a subset of the REGs, where the subset consists of the REGs that overlap the ‘U’ RB set and/or guard band. In this context ‘puncturing’ means that the UE does not attempt to receive PDCCH in those REGs. The UE may set the soft values of the PDCCH bits corresponding to these REGs to zero.

### Embodiment #5: Handling of UL Signals/Channels that Overlap ‘D’ RB Set

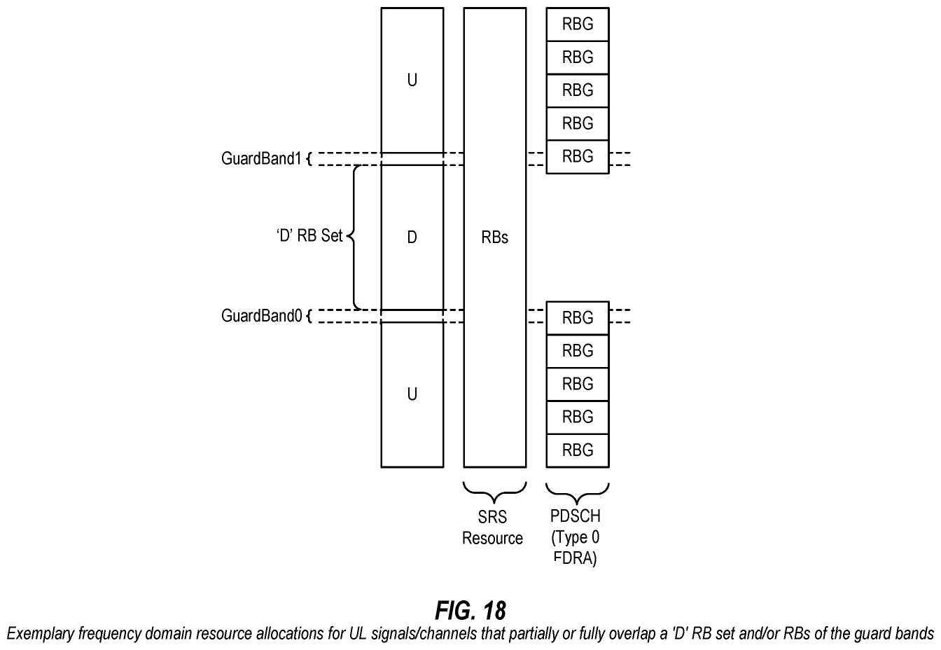

This embodiment discloses UE procedures for handling UL signals or channels that either fully or partially overlap RBs of a ‘D’ RB set and/or overlap RBs of one or both guard bands on either side of a ‘D’ RB set. This situation can occur, for example, if an SRS resource is configured a number of RBs that span the full carrier bandwidth. Another example is if the Type0 FDRA for Physical Uplink Shared Channel (PUSCH) indicates one or more resource block groups (RBGs) that partially overlaps a ‘D’ RB set and/or RBs of a guard band. These two scenarios are illustrated in FIG. 18.

The following sub-embodiments for Embodiment #5 are disclosed:

Embodiment 5-1: SRS If a UE receives an SRS configuration in which one or more RBs overlap a ‘D’ RB set and/or a guard band on one or both sides of the ‘D’ RB set, the UE does not transmit SRS in for those RBs of the configuration.

### Embodiment 5-2: PUSCH/CG

If a UE receives a FDRA for PUSCH or Configured Grant (CG) in which one or more RBs overlap a ‘D’ RB set and/or a guard band on one or both sides of the ‘D’ RB set, the UE rate matches around those RBs. In this context ‘rate matching’ means that the UE assumes that resources are not available for transmission of PUSCH in those RBs.

For the case of Type0 FDRA for PUSCH, the UE rate matches around all RBs of a Resource Block Group (RBG) that overlaps the ‘D’ RB set and/or guard band. In a variation, the UE rate matches around a subset of the RBs of the RBG, where the subset consists of the RBs that overlap the ‘D’ RB set and/or guard band.

### Further Description Related to All Embodiments

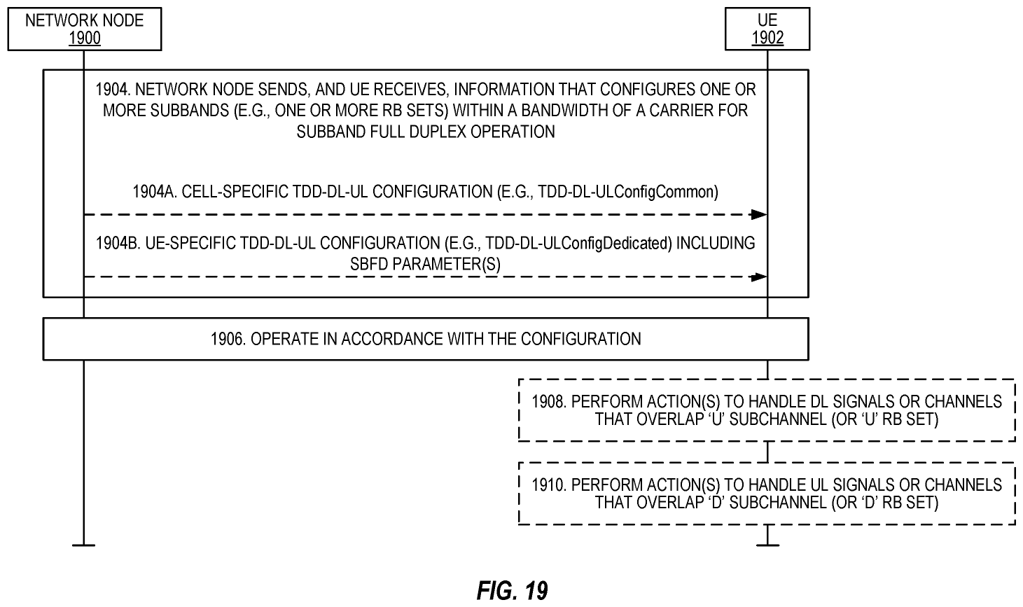

FIG. 19 illustrates the operation of a network node 1900 (e.g., a base station such as, e.g., a gNB or a network node that performs some of the functionality of a base station such as, e.g., a gNB-Central Unit (CU) or gNB-Distributed Unit (DU)) and a UE 1902 in accordance with at least some of the embodiments described above. Optional steps are represented by dashed lines/boxes. As illustrated, the network node 1900 sends, to the UE 1902, information that configures one or more subbands (e.g., one or more RB sets) within a bandwidth of a carrier for subband full duplex operation (step 1904). Note that this information may be sent to the UE 1902 (and thus received by the UE 1902) in one or more messages via any desired type of signaling or any desired combination of signaling (e.g., RRC, Downlink Control Information (DCI), Medium Access Control (MAC) Control Element (CE), or combination thereof). However, in one embodiment, the received information is provided via RRC signaling using one or more IEs (e.g., TDD-DL-UL-ConfigCommon IE and TDD-DL-UL-ConfigDedicated IE including one or more SBFD parameters as shown in steps 1904A and 1904B). The information received in step 1904 may configure the UE in accordance with any of Embodiments 1, 2, or 3 or any of the described sub-embodiments, variations, embodiments, or examples described above. Thus, the details described above regarding Embodiments 1, 2, or 3 (and any respective sub-embodiments) are equally applicable here. The UE 1902 then operates in accordance with the received information (step 1906). During operation, the UE 1902 may perform one or more actions to handle DL signals or channels that overlap with a ‘U’ subchannel (or ‘U’ RB set) as described with respect to Embodiment 4 and its sub-embodiments above (step 1908). The UE 1902 may perform one or more actions to handle UL signals or channels that overlap with a ‘D’ subchannel (or ‘D’ RB set) as described with respect to Embodiment 5 and its sub-embodiments above (step 1910).

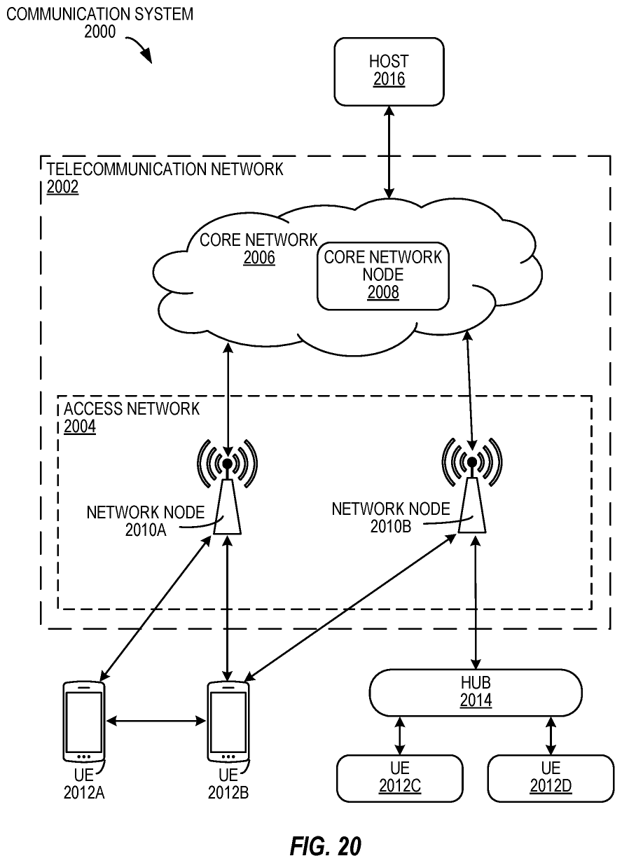

FIG. 20 shows an example of a communication system 2000 in accordance with some embodiments.

In the example, the communication system 2000 includes a telecommunication network 2002 that includes an access network 2004, such as a Radio Access Network (RAN), and a core network 2006, which includes one or more core network nodes 2008. The access network 2004 includes one or more access network nodes, such as network nodes 2010A and 2010B (one or more of which may be generally referred to as network nodes 2010), or any other similar Third Generation Partnership Project (3GPP) access node or non-3GPP Access Point (AP). The network nodes 2010 facilitate direct or indirect connection of User Equipment (UE), such as by connecting UEs 2012A, 2012B, 2012C, and 2012D (one or more of which may be generally referred to as UEs 2012) to the core network 2006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2000 may include any number of wired or wireless networks, network nodes, UEs, and/or any other components or systems that may facilitate or participate in the communication of data and/or signals whether via wired or wireless connections. The communication system 2000 may include and/or interface with any type of communication, telecommunication, data, cellular, radio network, and/or other similar type of system.

The UEs 2012 may be any of a wide variety of communication devices, including wireless devices arranged, configured, and/or operable to communicate wirelessly with the network nodes 2010 and other communication devices. Similarly, the network nodes 2010 are arranged, capable, configured, and/or operable to communicate directly or indirectly with the UEs 2012 and/or with other network nodes or equipment in the telecommunication network 2002 to enable and/or provide network access, such as wireless network access, and/or to perform other functions, such as administration in the telecommunication network 2002.

In the depicted example, the core network 2006 connects the network nodes 2010 to one or more hosts, such as host 2016. These connections may be direct or indirect via one or more intermediary networks or devices. In other examples, network nodes may be directly coupled to hosts. The core network 2006 includes one more core network nodes (e.g., core network node 2008) that are structured with hardware and software components. Features of these components may be substantially similar to those described with respect to the UEs, network nodes, and/or hosts, such that the descriptions thereof are generally applicable to the corresponding components of the core network node 2008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 2016 may be under the ownership or control of a service provider other than an operator or provider of the access network 2004 and/or the telecommunication network 2002, and may be operated by the service provider or on behalf of the service provider. The host 2016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2000 of FIG. 20 enables connectivity between the UEs, network nodes, and hosts. In that sense, the communication system 2000 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 2002 is a cellular network that implements 3GPP standardized features. Accordingly, the telecommunication network 2002 may support network slicing to provide different logical networks to different devices that are connected to the telecommunication network 2002. For example, the telecommunication network 2002 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 2012 are configured to transmit and/or receive information without direct human interaction. For instance, a UE may be designed to transmit information to the access network 2004 on a predetermined schedule, when triggered by an internal or external event, or in response to requests from the access network 2004. Additionally, a UE may be configured for operating in single-or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 2014 communicates with the access network 2004 to facilitate indirect communication between one or more UEs (e.g., UE 2012C and/or 2012D) and network nodes (e.g., network node 2010B). In some examples, the hub 2014 may be a controller, router, content source and analytics, or any of the other communication devices described herein regarding UEs. For example, the hub 2014 may be a broadband router enabling access to the core network 2006 for the UEs. As another example, the hub 2014 may be a controller that sends commands or instructions to one or more actuators in the UEs. Commands or instructions may be received from the UEs, network nodes 2010, or by executable code, script, process, or other instructions in the hub 2014. As another example, the hub 2014 may be a data collector that acts as temporary storage for UE data and, in some embodiments, may perform analysis or other processing of the data. As another example, the hub 2014 may be a content source. For example, for a UE that is a Virtual Reality (VR) headset, display, loudspeaker or other media delivery device, the hub 2014 may retrieve VR assets, video, audio, or other media or data related to sensory information via a network node, which the hub 2014 then provides to the UE either directly, after performing local processing, and/or after adding additional local content. In still another example, the hub 2014 acts as a proxy server or orchestrator for the UEs, in particular in if one or more of the UEs are low energy IoT devices.

The hub 2014 may have a constant/persistent or intermittent connection to the network node 2010B. The hub 2014 may also allow for a different communication scheme and/or schedule between the hub 2014 and UEs (e.g., UE 2012C and/or 2012D), and between the hub 2014 and the core network 2006. In other examples, the hub 2014 is connected to the core network 2006 and/or one or more UEs via a wired connection. Moreover, the hub 2014 may be configured to connect to a Machine-to-Machine (M2M) service provider over the access network 2004 and/or to another UE over a direct connection. In some scenarios, UEs may establish a wireless connection with the network nodes 2010 while still connected via the hub 2014 via a wired or wireless connection. In some embodiments, the hub 2014 may be a dedicated hub—that is, a hub whose primary function is to route communications to/from the UEs from/to the network node 2010B. In other embodiments, the hub 2014 may be a non-dedicated hub—that is, a device which is capable of operating to route communications between the UEs and the network node 2010B, but which is additionally capable of operating as a communication start and/or end point for certain data channels.

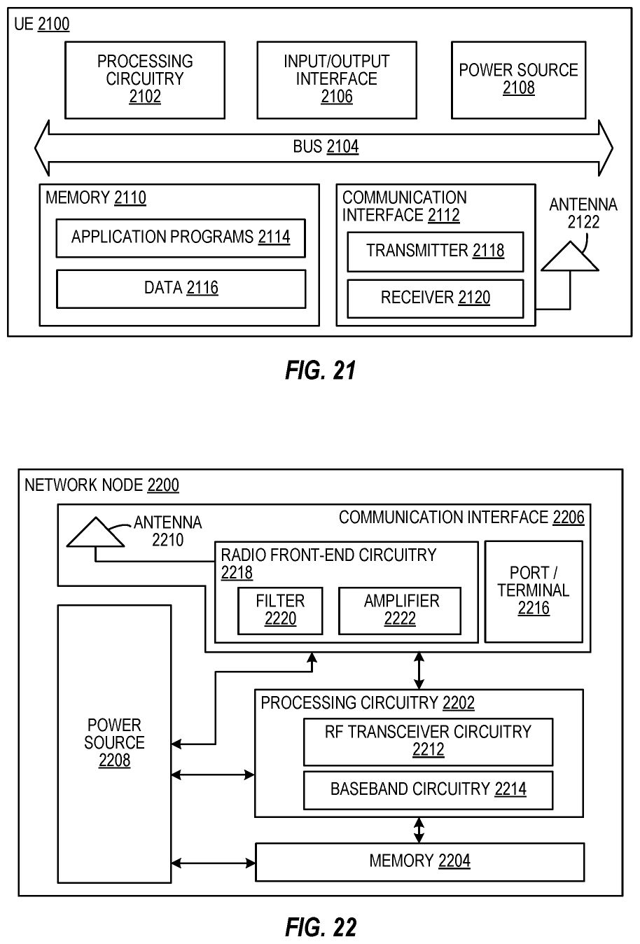

FIG. 21 shows a UE 2100 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2100 includes processing circuitry 2102 that is operatively coupled via a bus 2104 to an input/output interface 2106, a power source 2108, memory 2110, a communication interface 2112, and/or any other component, or any combination thereof. Certain UEs may utilize all or a subset of the components shown in FIG. 21. The level of integration between the components may vary from one UE to another UE. Further, certain UEs may contain multiple instances of a component, such as multiple processors, memories, transceivers, transmitters, receivers, etc.

The processing circuitry 2102 is configured to process instructions and data and may be configured to implement any sequential state machine operative to execute instructions stored as machine-readable computer programs in the memory 2110. The processing circuitry 2102 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 2102 may include multiple Central Processing Units (CPUs).

In the example, the input/output interface 2106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2108 is structured as a battery or battery pack. Other types of power sources, such as an external power source (e.g., an electricity outlet), photovoltaic device, or power cell, may be used. The power source 2108 may further include power circuitry for delivering power from the power source 2108 itself, and/or an external power source, to the various parts of the UE 2100 via input circuitry or an interface such as an electrical power cable. Delivering power may be, for example, for charging the power source 2108. Power circuitry may perform any formatting, converting, or other modification to the power from the power source 2108 to make the power suitable for the respective components of the UE 2100 to which power is supplied.

The memory 2110 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 2110 includes one or more application programs 2114, such as an operating system, web browser application, a widget, gadget engine, or other application, and corresponding data 2116. The memory 2110 may store, for use by the UE 2100, any of a variety of various operating systems or combinations of operating systems.

The memory 2110 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 2110 may allow the UE 2100 to access instructions, application programs, and the like stored on transitory or non-transitory memory media, to off-load data, or to upload data. An article of manufacture, such as one utilizing a communication system, may be tangibly embodied as or in the memory 2110, which may be or comprise a device-readable storage medium.

The processing circuitry 2102 may be configured to communicate with an access network or other network using the communication interface 2112. The communication interface 2112 may comprise one or more communication subsystems and may include or be communicatively coupled to an antenna 2122. The communication interface 2112 may include one or more transceivers used to communicate, such as by communicating with one or more remote transceivers of another device capable of wireless communication (e.g., another UE or a network node in an access network). Each transceiver may include a transmitter 2118 and/or a receiver 2120 appropriate to provide network communications (e.g., optical, electrical, frequency allocations, and so forth). Moreover, the transmitter 2118 and receiver 2120 may be coupled to one or more antennas (e.g., the antenna 2122) and may share circuit components, software, or firmware, or alternatively be implemented separately.

In the illustrated embodiment, communication functions of the communication interface 2112 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 2112, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2100 shown in FIG. 21.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 22 shows a network node 2200 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2200 includes processing circuitry 2202, memory 2204, a communication interface 2206, and a power source 2208. The network node 2200 may be composed of multiple physically separate components (e.g., a Node B component and an RNC component, or a BTS component and a BSC component, etc.), which may each have their own respective components. In certain scenarios in which the network node 2200 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 2200 may be configured to support multiple RATs. In such embodiments, some components may be duplicated (e.g., separate memory 2204 for different RATs) and some components may be reused (e.g., an antenna 2210 may be shared by different RATs). The network node 2200 may also include multiple sets of the various illustrated components for different wireless technologies integrated into network node 2200, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 2200.

The processing circuitry 2202 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 2200 components, such as the memory 2204, to provide network node 2200 functionality.

In some embodiments, the processing circuitry 2202 includes a System on a Chip (SOC). In some embodiments, the processing circuitry 2202 includes one or more of Radio Frequency (RF) transceiver circuitry 2212 and baseband processing circuitry 2214. In some embodiments, the RF transceiver circuitry 2212 and the baseband processing circuitry 2214 may be on separate chips (or sets of chips), boards, or units, such as radio units and digital units. In alternative embodiments, part or all of the RF transceiver circuitry 2212 and the baseband processing circuitry 2214 may be on the same chip or set of chips, boards, or units.

The memory 2204 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 2202. The memory 2204 may store any suitable instructions, data, or information, including a computer program, software, an application including one or more of logic, rules, code, tables, and/or other instructions capable of being executed by the processing circuitry 2202 and utilized by the network node 2200. The memory 2204 may be used to store any calculations made by the processing circuitry 2202 and/or any data received via the communication interface 2206. In some embodiments, the processing circuitry 2202 and the memory 2204 are integrated.

The communication interface 2206 is used in wired or wireless communication of signaling and/or data between a network node, access network, and/or UE. As illustrated, the communication interface 2206 comprises port(s)/terminal(s) 2216 to send and receive data, for example to and from a network over a wired connection. The communication interface 2206 also includes radio front-end circuitry 2218 that may be coupled to, or in certain embodiments a part of, the antenna 2210. The radio front-end circuitry 2218 comprises filters 2220 and amplifiers 2222. The radio front-end circuitry 2218 may be connected to the antenna 2210 and the processing circuitry 2202. The radio front-end circuitry 2218 may be configured to condition signals communicated between the antenna 2210 and the processing circuitry 2202. The radio front-end circuitry 2218 may receive digital data that is to be sent out to other network nodes or UEs via a wireless connection. The radio front-end circuitry 2218 may convert the digital data into a radio signal having the appropriate channel and bandwidth parameters using a combination of the filters 2220 and/or the amplifiers 2222. The radio signal may then be transmitted via the antenna 2210. Similarly, when receiving data, the antenna 2210 may collect radio signals which are then converted into digital data by the radio front-end circuitry 2218. The digital data may be passed to the processing circuitry 2202. In other embodiments, the communication interface 2206 may comprise different components and/or different combinations of components.

In certain alternative embodiments, the network node 2200 does not include separate radio front-end circuitry 2218; instead, the processing circuitry 2202 includes radio front-end circuitry and is connected to the antenna 2210. Similarly, in some embodiments, all or some of the RF transceiver circuitry 2212 is part of the communication interface 2206. In still other embodiments, the communication interface 2206 includes the one or more ports or terminals 2216, the radio front-end circuitry 2218, and the RF transceiver circuitry 2212 as part of a radio unit (not shown), and the communication interface 2206 communicates with the baseband processing circuitry 2214, which is part of a digital unit (not shown).

The antenna 2210 may include one or more antennas, or antenna arrays, configured to send and/or receive wireless signals. The antenna 2210 may be coupled to the radio front-end circuitry 2218 and may be any type of antenna capable of transmitting and receiving data and/or signals wirelessly. In certain embodiments, the antenna 2210 is separate from the network node 2200 and connectable to the network node 2200 through an interface or port.

The antenna 2210, the communication interface 2206, and/or the processing circuitry 2202 may be configured to perform any receiving operations and/or certain obtaining operations described herein as being performed by the network node 2200. Any information, data, and/or signals may be received from a UE, another network node, and/or any other network equipment. Similarly, the antenna 2210, the communication interface 2206, and/or the processing circuitry 2202 may be configured to perform any transmitting operations described herein as being performed by the network node 2200. Any information, data, and/or signals may be transmitted to a UE, another network node, and/or any other network equipment.

The power source 2208 provides power to the various components of the network node 2200 in a form suitable for the respective components (e.g., at a voltage and current level needed for each respective component). The power source 2208 may further comprise, or be coupled to, power management circuitry to supply the components of the network node 2200 with power for performing the functionality described herein. For example, the network node 2200 may be connectable to an external power source (e.g., the power grid or an electricity outlet) via input circuitry or an interface such as an electrical cable, whereby the external power source supplies power to power circuitry of the power source 2208. As a further example, the power source 2208 may comprise a source of power in the form of a battery or battery pack which is connected to, or integrated in, power circuitry. The battery may provide backup power should the external power source fail.

Embodiments of the network node 2200 may include additional components beyond those shown in FIG. 22 for providing certain aspects of the network node's functionality, including any of the functionality described herein and/or any functionality necessary to support the subject matter described herein. For example, the network node 2200 may include user interface equipment to allow input of information into the network node 2200 and to allow output of information from the network node 2200. This may allow a user to perform diagnostic, maintenance, repair, and other administrative functions for the network node 2200.

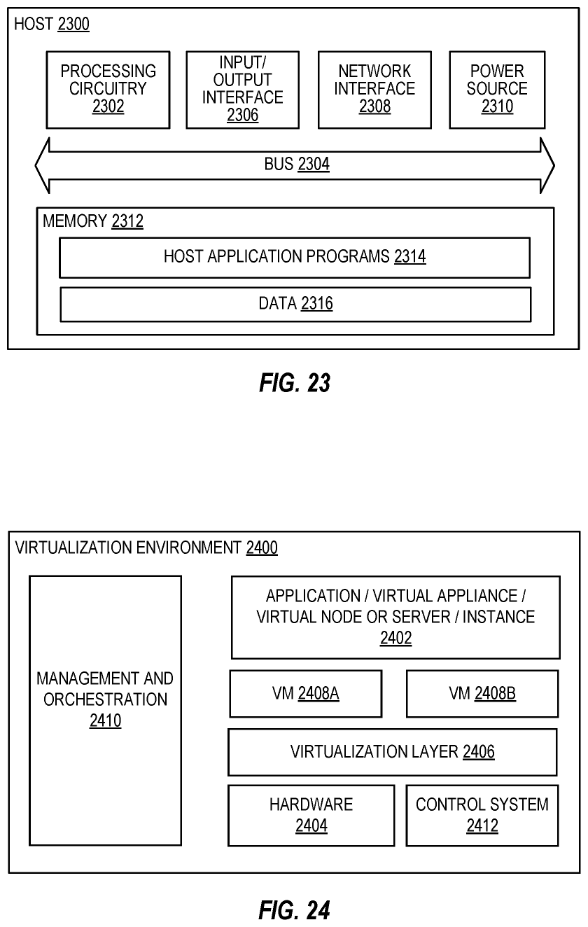

FIG. 23 is a block diagram of a host 2300, which may be an embodiment of the host 2016 of FIG. 20, in accordance with various aspects described herein. As used herein, the host 2300 may be or comprise various combinations of hardware and/or software including a standalone server, a blade server, a cloud-implemented server, a distributed server, a virtual machine, container, or processing resources in a server farm. The host 2300 may provide one or more services to one or more UEs.

The host 2300 includes processing circuitry 2302 that is operatively coupled via a bus 2304 to an input/output interface 2306, a network interface 2308, a power source 2310, and memory 2312. Other components may be included in other embodiments. Features of these components may be substantially similar to those described with respect to the devices of previous figures, such as FIGS. 21 and 22, such that the descriptions thereof are generally applicable to the corresponding components of the host 2300.

The memory 2312 may include one or more computer programs including one or more host application programs 2314 and data 2316, which may include user data, e.g. data generated by a UE for the host 2300 or data generated by the host 2300 for a UE. Embodiments of the host 2300 may utilize only a subset or all of the components shown. The host application programs 2314 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 2314 may also provide for user authentication and licensing checks and may periodically report health, routes, and content availability to a central node, such as a device in or on the edge of a core network. Accordingly, the host 2300 may select and/or indicate a different host for Over-The-Top (OTT) services for a UE. The host application programs 2314 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 24 is a block diagram illustrating a virtualization environment 2400 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 2400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2406 (also referred to as hypervisors or VM Monitors (VMMs)), provide VMs 2408A and 2408B (one or more of which may be generally referred to as VMs 2408), and/or perform any of the functions, features, and/or benefits described in relation with some embodiments described herein. The virtualization layer 2406 may present a virtual operating platform that appears like networking hardware to the VMs 2408.

The VMs 2408 comprise virtual processing, virtual memory, virtual networking, or interface and virtual storage, and may be run by a corresponding virtualization layer 2406. Different embodiments of the instance of a virtual appliance 2402 may be implemented on one or more of the VMs 2408, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 2408 may be a software implementation of a physical machine that runs programs as if they were executing on a physical, non-virtualized machine. Each of the VMs 2408, and that part of the hardware 2404 that executes that VM, be it hardware dedicated to that VM and/or hardware shared by that VM with others of the VMs 2408, forms separate virtual network elements. Still in the context of NFV, a virtual network function is responsible for handling specific network functions that run in one or more VMs 2408 on top of the hardware 2404 and corresponds to the application 2402.

The hardware 2404 may be implemented in a standalone network node with generic or specific components. The hardware 2404 may implement some functions via virtualization. Alternatively, the hardware 2404 may be part of a larger cluster of hardware (e.g., such as in a data center or CPE) where many hardware nodes work together and are managed via management and orchestration 2410, which, among others, oversees lifecycle management of the applications 2402. In some embodiments, the hardware 2404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 2412 which may alternatively be used for communication between hardware nodes and radio units.

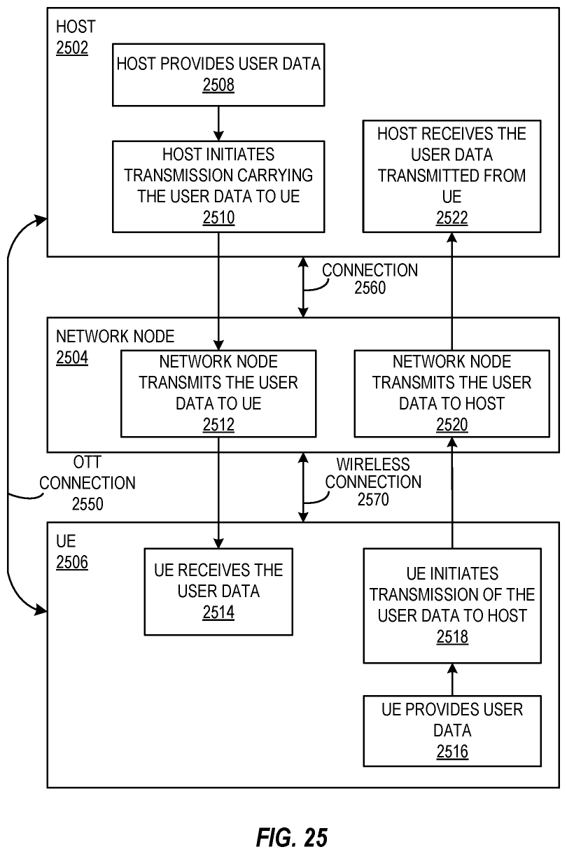

FIG. 25 shows a communication diagram of a host 2502 communicating via a network node 2504 with a UE 2506 over a partially wireless connection in accordance with some embodiments. Example implementations, in accordance with various embodiments, of the UE (such as the UE 2012A of FIG. 20 and/or the UE 2100 of FIG. 21), the network node (such as the network node 2010A of FIG. 20 and/or the network node 2200 of FIG. 22), and the host (such as the host 2016 of FIG. 20 and/or the host 2300 of FIG. 23) discussed in the preceding paragraphs will now be described with reference to FIG. 25.

Like the host 2300, embodiments of the host 2502 include hardware, such as a communication interface, processing circuitry, and memory. The host 2502 also includes software, which is stored in or is accessible by the host 2502 and executable by the processing circuitry. The software includes a host application that may be operable to provide a service to a remote user, such as the UE 2506 connecting via an OTT connection 2550 extending between the UE 2506 and the host 2502. In providing the service to the remote user, a host application may provide user data which is transmitted using the OTT connection 2550.

The network node 2504 includes hardware enabling it to communicate with the host 2502 and the UE 2506 via a connection 2560. The connection 2560 may be direct or pass through a core network (like the core network 2006 of FIG. 20) and/or one or more other intermediate networks, such as one or more public, private, or hosted networks. For example, an intermediate network may be a backbone network or the Internet.

The UE 2506 includes hardware and software, which is stored in or accessible by the UE 2506 and executable by the UE's processing circuitry. The software includes a client application, such as a web browser or operator-specific “app” that may be operable to provide a service to a human or non-human user via the UE 2506 with the support of the host 2502. In the host 2502, an executing host application may communicate with the executing client application via the OTT connection 2550 terminating at the UE 2506 and the host 2502. In providing the service to the user, the UE's client application may receive request data from the host's host application and provide user data in response to the request data. The OTT connection 2550 may transfer both the request data and the user data. The UE's client application may interact with the user to generate the user data that it provides to the host application through the OTT connection 2550.

The OTT connection 2550 may extend via the connection 2560 between the host 2502 and the network node 2504 and via a wireless connection 2570 between the network node 2504 and the UE 2506 to provide the connection between the host 2502 and the UE 2506. The connection 2560 and the wireless connection 2570, over which the OTT connection 2550 may be provided, have been drawn abstractly to illustrate the communication between the host 2502 and the UE 2506 via the network node 2504, without explicit reference to any intermediary devices and the precise routing of messages via these devices.

As an example of transmitting data via the OTT connection 2550, in step 2508, the host 2502 provides user data, which may be performed by executing a host application. In some embodiments, the user data is associated with a particular human user interacting with the UE 2506. In other embodiments, the user data is associated with a UE 2506 that shares data with the host 2502 without explicit human interaction. In step 2510, the host 2502 initiates a transmission carrying the user data towards the UE 2506. The host 2502 may initiate the transmission responsive to a request transmitted by the UE 2506. The request may be caused by human interaction with the UE 2506 or by operation of the client application executing on the UE 2506. The transmission may pass via the network node 2504 in accordance with the teachings of the embodiments described throughout this disclosure. Accordingly, in step 2512, the network node 2504 transmits to the UE 2506 the user data that was carried in the transmission that the host 2502 initiated, in accordance with the teachings of the embodiments described throughout this disclosure. In step 2514, the UE 2506 receives the user data carried in the transmission, which may be performed by a client application executed on the UE 2506 associated with the host application executed by the host 2502.

In some examples, the UE 2506 executes a client application which provides user data to the host 2502. The user data may be provided in reaction or response to the data received from the host 2502. Accordingly, in step 2516, the UE 2506 may provide user data, which may be performed by executing the client application. In providing the user data, the client application may further consider user input received from the user via an input/output interface of the UE 2506. Regardless of the specific manner in which the user data was provided, the UE 2506 initiates, in step 2518, transmission of the user data towards the host 2502 via the network node 2504. In step 2520, in accordance with the teachings of the embodiments described throughout this disclosure, the network node 2504 receives user data from the UE 2506 and initiates transmission of the received user data towards the host 2502. In step 2522, the host 2502 receives the user data carried in the transmission initiated by the UE 2506.

One or more of the various embodiments improve the performance of OTT services provided to the UE 2506 using the OTT connection 2550, in which the wireless connection 2570 forms the last segment.

In an example scenario, factory status information may be collected and analyzed by the host 2502. As another example, the host 2502 may process audio and video data which may have been retrieved from a UE for use in creating maps. As another example, the host 2502 may collect and analyze real-time data to assist in controlling vehicle congestion (e.g., controlling traffic lights). As another example, the host 2502 may store surveillance video uploaded by a UE. As another example, the host 2502 may store or control access to media content such as video, audio, VR, or AR which it can broadcast, multicast, or unicast to UEs. As other examples, the host 2502 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 2550 between the host 2502 and the UE 2506 in response to variations in the measurement results. The measurement procedure and/or the network functionality for reconfiguring the OTT connection 2550 may be implemented in software and hardware of the host 2502 and/or the UE 2506. In some embodiments, sensors (not shown) may be deployed in or in association with other devices through which the OTT connection 2550 passes; the sensors may participate in the measurement procedure by supplying values of the monitored quantities exemplified above, or by supplying values of other physical quantities from which software may compute or estimate the monitored quantities. The reconfiguring of the OTT connection 2550 may include message format, retransmission settings, preferred routing, etc.; the reconfiguring need not directly alter the operation of the network node 2504. Such procedures and functionalities may be known and practiced in the art. In certain embodiments, measurements may involve proprietary UE signaling that facilitates measurements of throughput, propagation times, latency, and the like by the host 2502. The measurements may be implemented in that software causes messages to be transmitted, in particular empty or ‘dummy’ messages, using the OTT connection 2550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### GROUP A EMBODIMENTS

Embodiment 1: A method performed by a User Equipment, UE, (1902), the method comprising: receiving (1904), from a network node (1900), information that configures one or more subbands within a bandwidth of a carrier for subband full duplex operation; and operating (1906) in accordance with the received information.

Embodiment 2: The method of embodiment 1 wherein the information comprises: first information that configures a cell-specific Time Division Duplexing, TDD, symbol pattern for the carrier, wherein the TDD symbol pattern comprises a set of flexible symbols; and second information that configures, for each flexible symbol from at least a subset of the set of flexible symbols within the TDD symbol pattern, one or more subbands for subband full duplex operation within the flexible symbol.

Embodiment 3: The method of embodiment 2 wherein receiving (1904) the information comprises: receiving (1904A) a cell-specific TDD downlink-uplink configuration that comprises the first information; and receiving (1904B) a UE-specific TDD downlink-uplink configuration that comprises the second information.

Embodiment 4: The method of embodiment 2 or 3 wherein the same one or more subbands for subband full duplex operation are configured in each of the at least a subset of the set of flexible symbols.

Embodiment 5: The method of embodiment 2 or 3 wherein at least one different subband for subband full duplex operation is configured for at least two of the at least a subset of the set of flexible symbols.

Embodiment 6: The method of any of embodiments 2 to 5 wherein the second information further configures a transmission direction (i.e., either uplink or downlink) for each of the one or more subbands for each of the at least a subset of the set of flexible symbols.

Embodiment 7: The method of any of embodiments 2 to 5 wherein a transmission direction (i.e., either uplink or downlink) for each of the one or more subbands for each of the at least a subset of the set of flexible symbols is predefined.

Embodiment 8: The method of embodiment 6 or 7 wherein: the same one or more subbands are configured for all of the at least a subset of flexible symbols configured for subband full duplex operation; and for each subband of the one or more subbands, the transmission direction is the same within the subband for all of the at least a subset of the set of flexible symbols configured for subband full duplex operation.

Embodiment 9: The method of embodiment 6 or 7 wherein: the same one or more subbands are configured for all of the at least a subset of flexible symbols configured for subband full duplex operation; and for at least one subband of the one or more subbands, the transmission direction is different within the subband for at least two of the at least a subset of the set of flexible symbols configured for subband full duplex operation.

Embodiment 10: The method of any of embodiments 2 to 9 wherein the at least a subset of the set of flexible symbols configured for subband full duplex operation is predefined.

Embodiment 11: The method of any of embodiments 2 to 9 wherein the received information further comprises information that indicates the at least a subset of the set of flexible symbols configured for subband full duplex operation.

Embodiment 12: The method of embodiment 1 wherein the information comprises: first information that configures a cell-specific Time Division Duplexing, TDD, symbol pattern for the carrier, wherein the TDD symbol pattern comprises a set of downlink symbols; and second information that configures, for each downlink symbol from at least a subset of the set of downlink symbols within the TDD symbol pattern, one or more subbands for subband full duplex operation within the downlink symbol.

Embodiment 13: The method of embodiment 12 wherein, for each downlink symbol from the at least a subset of the set of downlink symbols within the TDD symbol pattern, the one or more subbands for subband full duplex operation within the downlink symbol consist of a single subband, wherein a transmission direction for the signal subband is the uplink direction.

Embodiment 14: The method of embodiment 13 wherein the received information further comprises information that indicates a guardband on either or both sides of the single subband.

Embodiment 15: The method of embodiment 13 or 14 wherein RBs that are not part of the single subband and optionally not part of the guardband(s) are implicitly indicated as being one or more subbands for downlink transmission for subband full duplex operation.

Embodiment 16: The method of any of embodiments 12 to 15 wherein the at least a subset of the set of downlink symbols that are configured for subband full duplex operation is predefined.

Embodiment 17: The method of any of embodiments 12 to 15 wherein the received information further comprises information that indicates the at least a subset of the set of downlink symbols that are configured for subband full duplex operation.

Embodiment 18: The method of embodiment 1 wherein the information comprises: first information that configures a cell-specific Time Division Duplexing, TDD, symbol pattern for the carrier, wherein the TDD symbol pattern comprises a set of uplink symbols; and second information that configures, for each uplink symbol from at least a subset of the set of uplink symbols within the TDD symbol pattern, one or more subbands for subband full duplex operation within the uplink symbol.

Embodiment 19: The method of embodiment 18 wherein, for each uplink symbol from the at least a subset of the set of uplink symbols within the TDD symbol pattern, the one or more subbands for subband full duplex operation within the uplink symbol consist of a single subband, wherein a transmission direction for the signal subband is the downlink direction.

Embodiment 20: The method of embodiment 19 wherein the received information further comprises information that indicates a guardband on either or both sides of the single subband.

Embodiment 21: The method of embodiment 19 or 20 wherein RBs that are not part of the single subband and optionally not part of the guardband(s) are implicitly indicated as being one or more subbands for uplink transmission for subband full duplex operation.

Embodiment 22: The method of any of embodiments 18 to 21 wherein the at least a subset of the set of uplink symbols that are configured for subband full duplex operation is predefined.

Embodiment 23: The method of any of embodiments 18 to 21 wherein the received information further comprises information that indicates the at least a subset of the set of uplink symbols that are configured for subband full duplex operation.

Embodiment 24: The method of any of embodiments 1 to 23 further comprising performing (1908) one or more actions to handle one or more downlink signals or one or more downlink channels that overlap at least one of the one or more subbands configured for uplink transmission for subband full duplex operation within at least one symbol.

Embodiment 25: The method of embodiment 24 wherein the one or more actions comprise: refraining from attempting to receive a downlink signal or channel in one or more RBs in which the downlink signal or channel overlaps at least one of the one or more subbands configured for uplink transmission for subband full duplex operation within at least one symbol; rate-matching around one or more RBs in which the downlink signal or channel overlaps at least one of the one or more subbands configured for uplink transmission for subband full duplex operation within at least one symbol; or puncturing a downlink signal or channel in one or more RBs in which the downlink signal or channel overlaps at least one of the one or more subbands configured for uplink transmission for subband full duplex operation within at least one symbol.

Embodiment 26: The method of any of embodiments 1 to 25 further comprising performing (1910) one or more actions to handle one or more uplink signals or one or more uplink channels that overlap at least one of the one or more subbands configured for downlink transmission for subband full duplex operation within at least one symbol. This includes refraining from transmitting an uplink signal or channel in one or more RBs in which the uplink signal or channel overlaps at least one of the one or more subbands configured for downlink transmission for subband full duplex operation within at least one symbol; or rate-matching around one or more RBs in which the uplink signal or channel overlaps at least one of the one or more subbands configured for downlink transmission for subband full duplex operation within at least one symbol.

Embodiment 27: The method of any of embodiments 1 to 26 wherein each of the one or more subbands is a set of one or more contiguous resource blocks, RBs.

Embodiment 28: The method of any of embodiments 1 to 27 wherein the one or more subbands comprise two or more subbands.

Embodiment 29: The method of any of the previous embodiments, further comprising: providing user data; and forwarding the user data to a host via the transmission to the network node.

### GROUP B EMBODIMENTS

Embodiment 30: A method performed by a network node (1900), the method comprising: transmitting (1904), to a User Equipment, UE, (1902), information that configures one or more subbands within a bandwidth of a carrier for subband full duplex operation.

Embodiment 31: The method of embodiment 30 further comprising operating (1906) in accordance with the transmitting information.

Embodiment 32: The method of any of the previous embodiments, further comprising: obtaining user data; and forwarding the user data to a host or a user equipment.

### GROUP C EMBODIMENTS

Embodiment 33: A user equipment comprising: processing circuitry configured to perform any of the steps of any of the Group A embodiments; and power supply circuitry configured to supply power to the processing circuitry.

Embodiment 34: A network node comprising: processing circuitry configured to perform any of the steps of any of the Group B embodiments; power supply circuitry configured to supply power to the processing circuitry.

Embodiment 35: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 36: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 37: The host of the previous embodiment, wherein the cellular network further includes a network node configured to communicate with the UE to transmit the user data to the UE from the host.

Embodiment 38: The host of the previous 2 embodiments, wherein: the processing circuitry of the host is configured to execute a host application, thereby providing the user data; and the host application is configured to interact with a client application executing on the UE, the client application being associated with the host application.

Embodiment 39: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 40: The method of the previous embodiment, further comprising: at the host, executing a host application associated with a client application executing on the UE to receive the user data from the UE.

Embodiment 41: The method of the previous embodiment, further comprising: at the host, transmitting input data to the client application executing on the UE, the input data being provided by executing the host application, wherein the user data is provided by the client application in response to the input data from the host application.

Embodiment 42: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 43: The host of the previous embodiment, wherein the cellular network further includes a network node configured to communicate with the UE to transmit the user data from the UE to the host.

Embodiment 44: The host of the previous 2 embodiments, wherein: the processing circuitry of the host is configured to execute a host application, thereby providing the user data; and the host application is configured to interact with a client application executing on the UE, the client application being associated with the host application.

Embodiment 45: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 46: The method of the previous embodiment, further comprising: at the host, executing a host application associated with a client application executing on the UE to receive the user data from the UE.

Embodiment 47: The method of the previous embodiment, further comprising: at the host, transmitting input data to the client application executing on the UE, the input data being provided by executing the host application, wherein the user data is provided by the client application in response to the input data from the host application.

Embodiment 48: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 49: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 50: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 51: The method of the previous embodiment, further comprising, at the network node, transmitting the user data provided by the host for the UE.

Embodiment 52: The method of any of the previous 2 embodiments, wherein the user data is provided at the host by executing a host application that interacts with a client application executing on the UE, the client application being associated with the host application.

Embodiment 53: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 54: The communication system of the previous embodiment, further comprising: the network node; and/or the user equipment.

Embodiment 55: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 56: The host of the previous 2 embodiments, wherein: the processing circuitry of the host is configured to execute a host application, thereby providing the user data; and the host application is configured to interact with a client application executing on the UE, the client application being associated with the host application.

Embodiment 57: The host of the any of the previous 2 embodiments, wherein the initiating receipt of the user data comprises requesting the user data.

Embodiment 58: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 59: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE), the method comprising:
receiving, from a network node, information that configures one or more subbands within a bandwidth of a carrier for subband full duplex operation, the information comprising:
first information that configures a cell-specific Time Division Duplexing (TDD), symbol pattern for the carrier, wherein the TDD symbol pattern comprises a set of symbols; and
second information that configures, for each symbol from at least a subset of the set of symbols within the TDD symbol pattern, one or more subbands for subband full duplex operation within the symbol; and
operating in accordance with the received information.

2. The method of claim 1 wherein the set of symbols comprises a set of flexible symbols.

3. The method of claim 2 wherein receiving the information comprises:
receiving a cell-specific TDD downlink-uplink configuration that comprises the first information; and
receiving a UE-specific configuration that comprises the second information.

4. The method of claim 2 wherein the same one or more subbands for subband full duplex operation are configured in each of the at least a subset of the set of flexible symbols.

5. The method of claim 2 wherein different one or more subbands for subband full duplex operation are configured for at least two of the at least a subset of the set of flexible symbols.

6. The method of claim 2 wherein the second information further configures a transmission direction for each of the one or more subbands for each of the at least a subset of the set of flexible symbols.

7. (canceled)

8. The method of claim 6 wherein:
the same one or more subbands are configured for all of the at least a subset of flexible symbols configured for subband full duplex operation; and
for each subband of the one or more subbands, the transmission direction is the same within the subband for all of the at least a subset of the set of flexible symbols configured for subband full duplex operation.

9. The method of claim 6 wherein:
the same one or more subbands are configured for all of the at least a subset of flexible symbols configured for subband full duplex operation; and
for at least one subband of the one or more subbands, the transmission direction is different within the subband for at least two of the at least a subset of the set of flexible symbols configured for subband full duplex operation.

10-11. (canceled)

12. The method of claim 1 wherein the set of symbols comprises a set of downlink symbols.

13. The method of claim 12 wherein, for each downlink symbol from the at least a subset of the set of downlink symbols within the TDD symbol pattern, the one or more subbands for subband full duplex operation within the downlink symbol consist of a single subband, wherein a transmission direction for the signal subband is the uplink direction.

14. The method of claim 13 wherein resource blocks that are not part of the single subband are implicitly indicated as being one or more subbands for downlink transmission for subband full duplex operation.

15. The method of claim 13 wherein the received information further comprises information that indicates a guardband on either or both sides of the single subband.

16. The method of claim 15 wherein resource blocks that are not part of the single subband and not part of the guardband on either or both sides of the single subband are implicitly indicated as being one or more subbands for downlink transmission for subband full duplex operation.

17-18. (canceled)

19. The method of claim 1 wherein the set of symbols comprises a set of uplink symbols.

20. The method of claim 19 wherein, for each uplink symbol from the at least a subset of the set of uplink symbols within the TDD symbol pattern, the one or more subbands for subband full duplex operation within the uplink symbol consist of a single subband, wherein a transmission direction for the signal subband is the downlink direction.

21. The method of claim 20 wherein resource blocks that are not part of the single subband are implicitly indicated as being one or more subbands for uplink transmission for subband full duplex operation.

22. The method of claim 20 wherein the received information further comprises information that indicates a guardband on either or both sides of the single subband.

23. The method of claim 22 wherein resource blocks that are not part of the single subband and not part of the guardband on either or both sides of the single subband are implicitly indicated as being one or more subbands for uplink transmission for subband full duplex operation.

24-31. (canceled)

32. The method of claim 1 further comprising performing one or more actions to handle one or more downlink signals or one or more downlink channels that overlap at least one of the one or more subbands configured for uplink transmission for subband full duplex operation within at least one symbol and/or overlap at least one guard band configured on either side of at least one of the one or more subbands configured for uplink transmission for subband full duplex operation within at least one symbol.

33-39. (canceled)

40. A User Equipment (UE), comprising:
a communication interface comprising a transmitter and a receiver; and
processing circuitry associated with the communication interface, the processing circuitry configured to cause the UE to:
receive, from a network node, information that configures one or more subbands within a bandwidth of a carrier for subband full duplex operation, the information comprising:
first information that configures a cell-specific Time Division Duplexing (TDD), symbol pattern for the carrier, wherein the TDD symbol pattern comprises a set of symbols; and
second information that configures, for each symbol from at least a subset of the set of within the TDD symbol pattern, one or more subbands for subband full duplex operation within the symbol; and
operate in accordance with the received information.

41-74. (canceled)

75-79. (canceled)
